(19) United States
(12) Patent Application Publication
(10) Pub. No.: US 2015/0319682 A1
(43) Pub. Date: Nov. 5, 2015

(54) COMMUNICATION SYSTEM, COMMUNICATION DEVICE, AND NETWORK CONNECTION CONTROL METHOD

(71) Applicant: NEC CORPORATION, Tokyo (JP)

(72) Inventor: Hiroaki AMINAKA, Tokyo (JP)

(21) Appl. No.: 14/649,291

(22) PCT Filed: Dec. 6, 2013
(86) PCT No.: PCT/JP2013/007204

§ 371 Date: Jun. 3, 2015

(30) Foreign Application Priority Data
Dec. 6, 2012 (JP) 2012-267722

(51) Int. Cl. H04W 48/18; H04W 8/20; H04W 36/26

(52) U.S. Cl. CPC H04W 48/18; H04W 36/26; H04W 8/20

(57) ABSTRACT

When a mobile station that is capable of wirelessly connecting directly to a mobile network connects to another mobile network via another mobile station, security is enhanced, so that the legitimate uses of networks are fostered. A first mobile station (10) that can connect to a first network (30) and a second mobile station (20) that can connect to a second network (40) are included, wherein the first mobile station has a function of connecting to the second network via the second mobile station, and a connection of the first mobile station to the second network is controlled based on information concerning a contract for communication service uses in the first network (mobile station contract information).

This application is a National Stage Entry of International Application No. PCT/JP2013/007204, filed Dec. 6, 2013, which is based upon and claims the benefit of the priority of Japanese Patent Application No. 2012-267722. The entire contents of the above-referenced applications are expressly incorporated herein by reference.

### TECHNICAL FIELD

The present invention relates to a wireless communication system and, more particularly, to communication control techniques for connecting a mobile station to a network.

### BACKGROUND ART

In recent years, mobile stations having wireless LAN (Local Area Network) functions and the like, such as multifunctional mobile telephones (smartphones) and mobile routers, are rapidly becoming prevalent. Such a mobile station is capable of connecting to a mobile network provided by a mobile service provider and the like and is also capable of connecting to another wireless terminal via the wireless LAN and the like. Accordingly, allowing such a mobile station to operate as a bridge or router makes it possible to provide communication services to another wireless terminal via the mobile network.

As an exemplary method of connecting a wireless terminal to a mobile network via the above-described mobile station, PTL 1 discloses a method for establishing a wireless connection of the wireless terminal by using a mobile station that provides the best wireless connection among multiple mobile stations.

### CITATION LIST

### Patent Literature

### [PTL 1]

International Publication Number WO03/039178

### SUMMARY OF INVENTION

### Technical Problem

However, with the recent prevalence of smartphones and the like, there arise cases where the wireless terminal described in PTL 1 itself is possibly a mobile station capable of connecting to another mobile network. Such a mobile station (hereinafter, referred to as first mobile station) can use both a first route and a second route, the first route passing through a mobile network to which its user subscribes and a second route passing through a mobile network to which a mobile station operating as a bridge/router as described above (hereinafter, referred to as second mobile station) subscribes. In such an environment, the pairing of the first and second mobile stations is very important because the first mobile station can access the other mobile network via the second mobile station.

In general, the security of a wireless LAN connection of the first mobile station to the second mobile station is controlled by using security information such as a WEP key or the like. However, since security information such as a WEP key or the like is set by a user him/herself, it can also come to a third party's knowledge. Under such circumstances, the security of a wireless connection of the first mobile station to the second mobile station cannot help being weak. Once this security information is known, access to the other mobile network can be made from any terminals (smartphones and game devices of other companies) via the second mobile station.

Accordingly, an object of the present invention is to provide a communication system, a communication device, and a network connection control method that can increase security and foster authorized uses when a mobile station capable of wirelessly connecting directly to a mobile network connects to another mobile network via another mobile station.

### Solution to Problem

A communication system according to the present invention is a communication system including a plurality of networks, comprising a first mobile station that can connect to a first network and a second mobile station that can connect to a second network, wherein the first mobile station has a function of connecting to the second network via the second mobile station, wherein a connection of the first mobile station to the second network is controlled based on information concerning a contract for communication service uses in the first network (hereinafter, referred to as mobile station contract information).

A network connection control method according to the present invention is a network connection control method in a communication system including a first mobile station that can connect to a first network and a second mobile station that can connect to a second network, wherein the method is for allowing the first mobile station to connect to the second network via the second mobile station, comprising: controlling a connection of the first mobile station to the second network, based on information concerning a contract for communication service uses in the first network (hereinafter, referred to as mobile station contract information).

A communication device according to the present invention is a communication device in a communication system including first and second networks and a mobile station that can connect to the first network, wherein the communication device can connect to the second network and has a function of allowing the mobile station to connect to the second network, comprising: connection control means for controlling a connection of the mobile station to the second network, based on information concerning a contract for communication service uses in the first network (hereinafter, referred to as mobile station contract information).

A communication device according to the present invention is a upper-level network device in a communication system including a first mobile station that can connect to a first network and a second mobile station that can connect to a second network, wherein the first mobile station has a function of connecting to the second network via the second mobile station, the upper-level network being provided in a upper-level network than a base station in the second network, comprising: connection control means for controlling a connection of the first mobile station to the second network, based on information concerning a contract for communication service uses in the first network (hereinafter, referred to as mobile station contract information).

A communication device according to the present invention is a communication device in a communication system including first and second networks and a mobile station that can connect to the second network, wherein the communication device can connect to the first network and is capable of wirelessly communicating with the mobile station, comprising: storage means for storing information concerning a contract for communication service uses in the first network (hereinafter, referred to as mobile station contract information); and connection control means for controlling a connection to the second network via the mobile station, based on the mobile station contract information.

### Advantageous Effects of Invention

According to the present invention, control is performed so as to allow a mobile station to connect to another network based on mobile station contract information, whereby it is possible to increase the security of a communication system and foster authorized uses.

### BRIEF DESCRIPTION OF DRAWINGS

FIG. 1 is a network diagram showing a schematic architecture of a communication system according to an exemplary embodiment of the present invention.

FIG. 2 is a flowchart showing a connection permission/non-permission determination procedure in a communication control method according to the present exemplary embodiment.

FIG. 3 is a block diagram showing a schematic configuration of a first mobile station in the present exemplary embodiment.

FIG. 4 is a block diagram showing a schematic configuration of a second mobile station in the present exemplary embodiment.

FIG. 5 is a block diagram showing a schematic configuration of a upper-level network device in the present exemplary embodiment.

FIG. 6 is a diagram of a communication control sequence in a communication system according to a first example of the present invention.

FIG. 7 is a flowchart showing communication control by the first mobile station in the first example.

FIG. 8 is a flowchart showing communication control by the second mobile station in the first example.

FIG. 9 is a block diagram showing an example of the first mobile station in the first example.

FIG. 10 is a block diagram showing an example of the second mobile station in the first example.

FIG. 11 is a diagram of a communication control sequence in a communication system according to a second example of the present invention.

FIG. 12 is a flowchart showing communication control by the second mobile station in the second example.

FIG. 13 is a flowchart showing communication control by the upper-level network device in the second example.

FIG. 14 is a diagram of a communication control sequence in a communication system according to a third example of the present invention.

FIG. 15 is a flowchart showing communication control by the first mobile station in the third example.

FIG. 16 is a diagram of a communication control sequence in a communication system according to a fourth example of the present invention.

FIG. 17 is a flowchart showing communication control by the first mobile station in the fourth example.

FIG. 18 is a diagram of a communication control sequence in a communication system according to a fifth example of the present invention.

FIG. 19 is a flowchart showing communication control by the first mobile station in the fifth example.

FIG. 20 is a flowchart showing communication control by the second mobile station in the fifth example.

### DESCRIPTION OF EMBODIMENTS

According to an exemplary embodiment of the present invention, it is determined, based on information concerning a contract for a mobile station that is capable of connecting to a network to use communication services in the network (hereinafter, referred to as mobile station contract information), whether or not to permit a connection when the mobile station connects to another network via another mobile station. Thereby, it is possible to prevent malicious uses of a system in which access to another network is possible via another mobile station, and thus to foster authorized or legitimate uses of networks. Hereinafter, an exemplary embodiment and examples of the present invention will be described in detail with reference to drawings.

### 1. Exemplary Embodiment

### 1.1) System Architecture

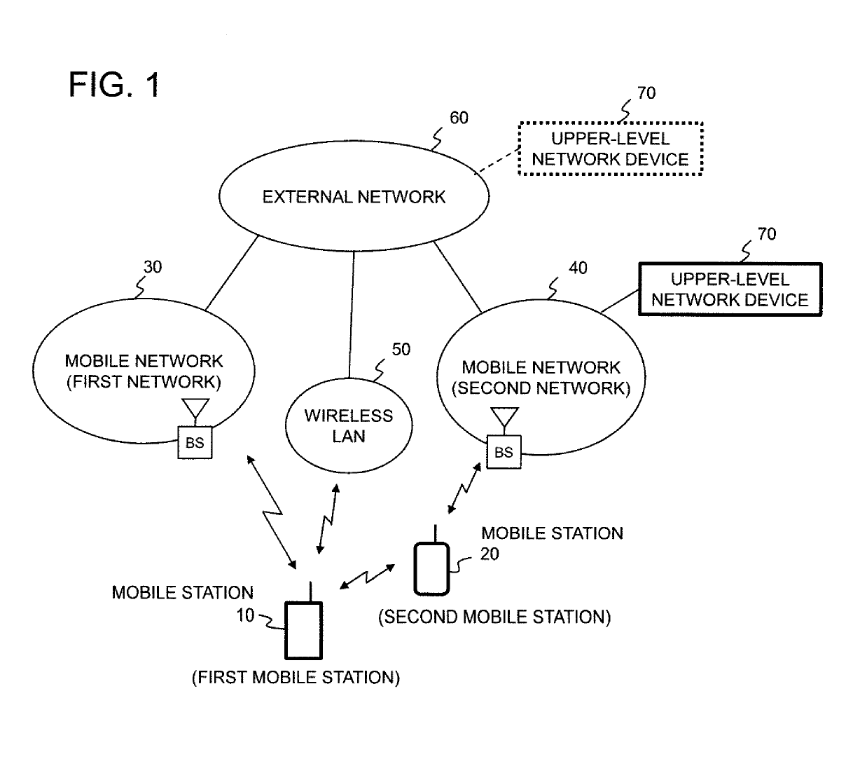

Referring to FIG. 1, a communication system according to an exemplary embodiment of the present invention includes a mobile station 10 that is capable of wirelessly connecting to a mobile network 30 and a wireless LAN 50, and a mobile station 20 that is capable of wirelessly connecting to a mobile network 40. It is assumed that the mobile station 10 can communicate with an external network 60 via each of the mobile network 30 and the wireless LAN 50, and also via the mobile station 20 and the mobile network 40, which will be described later.

The mobile networks 30 and 40 and the wireless LAN 50 are any one of a cellular network, a public wireless LAN, and the like provided by a telecommunication operator (mobile operator or wireless service provider). Typically, the mobile network 40 is a network that cannot be directly accessed by the mobile station 10, which can connect to the mobile network 30 and the wireless LAN 50. For example, the mobile station 10 cannot directly access the mobile network 40 when the mobile networks 30 and 40 are operated by different telecommunication operators. Moreover, if the mobile network operator is a MVNO (Mobile Virtual Network Operator), the mobile station 10 cannot access the mobile network 40 due to the contractual restrictions on service uses.

Further, for another example, in the case where the mobile networks 30 and 40 are of different cellular radio systems operated by the same telecommunication operator or different telecommunication operators, the mobile station 10 cannot access the mobile network 40 due to technical restrictions because, in general, support for different radio access technologies or different NAS protocols is required of the mobile station. Furthermore, the mobile station 10 cannot directly access the mobile network 40 when different authentications are required. For example, that applies to a case where authentications are different because the mobile networks were operated by different operators in the past even if they are being operated by the same telecommunication operator. Alternatively, when different authentications are required in different wireless systems, the mobile station 10 cannot directly access the mobile network 40 because contracts are different. Alternatively, when different frequencies are supported by the mobile stations 10 and 20, the mobile station 10 similarly cannot directly access the mobile network 40.

The external network 60 is a network with which the mobile station 10 or 20 can communicate via the mobile network 30 or 40 or the wireless LAN 50. The external network 60 is, for example, a packet data network, an IP (Internet Protocol) network, the Internet, or another mobile network. An end node communicating with the mobile station 10 may be, for example, a server computer, a personal computer, or a mobile station connected to the external network 60. Moreover, such an end node may be another mobile station connected to the mobile network 30 or 40. Note that communication between the mobile station 10 and the end node is, but is not limited to, for example, internet access, VoIP (Voice over IP) call, voice chat, video chat, video streaming, online game, or the like.

The mobile stations 10 and 20 can wirelessly communicate with each other. For example, a wireless connection between the mobile stations 10 and 20 can be established by using a radio access technology for Wireless LAN based on IEEE 802.11 series, Wireless PAN based on IEEE 802.15 series (e.g., Bluetooth™), or the like. Moreover, it is also possible that the mobile station 10 is a wireless LAN terminal and the mobile network 30 is a public wireless LAN.

The mobile station 20 operates as a bridge/router for transferring data of the mobile station 10. The same radio access technology or difference radio access technologies can be used for a wireless connection between the mobile stations 20 and 10 and a wireless connection between the mobile station 20 and the mobile network 40. The mobile station 20 is, for example, a mobile router, a smartphone with tethering function, or the like and can concurrently establish a connection to the mobile network 40 and a connection to the mobile station 10. That is, the mobile station 20 as a smartphone with tethering function establishes a wireless connection to a base station BS in the mobile network 40 by using a radio access technology for cellular networks, and the mobile station 20 as a mobile router establishes a wireless connection to the mobile station 10 by using a radio access technology for Wireless LAN or Wireless PAN.

As described above, the mobile station 10 is capable of connecting to the mobile network 40 via the mobile station 20. However, according to the present exemplary embodiment, it is determined whether or not to permit such a connection, based on the mobile station contract information of the mobile station 10, which will be described next. Note that it is sufficient that this connection permission/non-permission determination is performed by the mobile station 10 or 20, or at an upper-level network including a network device 70.

### 1.2) Connection Permission/Non-Permission Determination

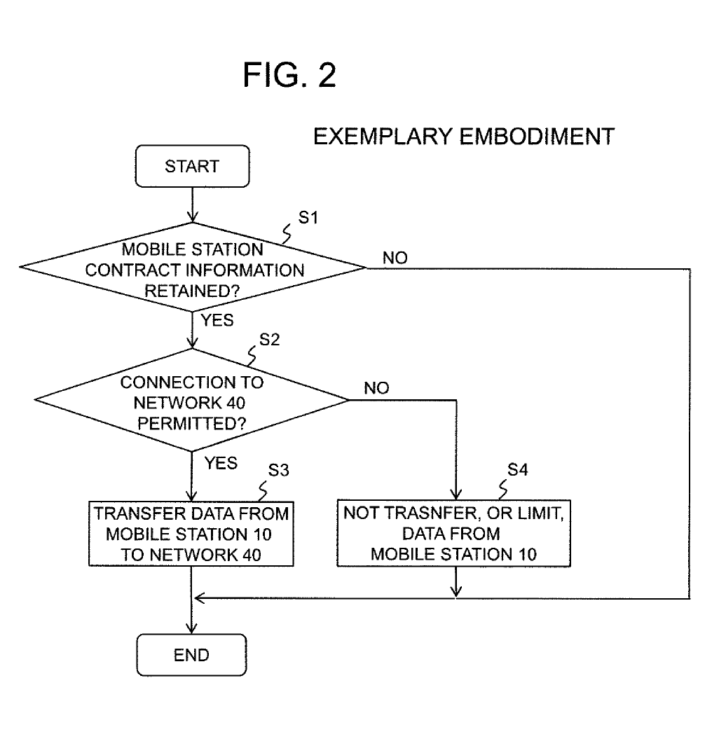

Referring to FIG. 2, when the mobile station 10 accesses the mobile station 20, it is determined whether or not to permit a connection, based on whether or not an access condition is satisfied. That is, a determining entity determines whether or not it already has the mobile station contract information of the mobile station 10 (Operation S1) and, when it has the mobile station contract information (Operation S1; YES), determines based on this mobile station contract information whether or not a connection to the mobile network 40 can be permitted (Operation S2). It is also possible that the mobile station 10 keeps the mobile station contract information and, by request, sends it to the requester, or that a network side keeps the mobile station contract information and the mobile station 10 or 20 downloads it as necessary.

When the mobile station contract information satisfies the predetermined access condition (Operation S2; YES), data from the mobile station 10 is transferred to the mobile network 40 via the mobile station 20 (Operation S3). When the mobile station contract information does not satisfy the predetermined access condition (Operation S2; NO), data from the mobile station 10 is not transferred to the mobile network 40 or is restricted (Operation S4).

The mobile station contract information is information concerning a line use contract made with a telecommunication operator when the mobile station 10 uses communication services of the mobile network 30, or additional information to such contract information. Specific examples of the mobile station contract information are as follows: information recorded on a SIM (Subscriber Identity Module) card; information on a communication plan indicating a contracted service use type; and an access key that is set, for example, when the mobile station 10 is handed over at a store, for the pairing between the mobile stations 10 and 20. Such mobile station contract information is used to determine whether or not its contents, under which a connection is requested, meet the predetermined access condition, whereby it is possible to give permission of a connection via the mobile station 20 only to a user under authorized contract with a specified telecommunication operator, an authorized user subscribing to a predetermined contract plan, or a user having set the pairing at a store. The predetermined access condition includes information specifying a party to the contract or part of the contents of the contract, such as, for example, a specified telecommunication operator, a specified contract plan, or a specified security key. Moreover, additional information to the mobile station contract information can also be obtained from the upper-level network.

Note that in Operation S4, it is also possible to give permission, without discarding data from the mobile station 10 that shall not be permitted, as a restricted connection such as low-speed communication. For example, it is also possible to configure the wireless communication services provided by the mobile station 20 such as to differ between the mobile station 10 of an authorized subscriber to the mobile network 30 and wireless terminals (e.g., game devices and the like) of other subscribers. That is, high-speed communication is always provided to subscribers to the mobile network 30, but communication provided to other users' terminals is limited to low speed.

Moreover, in Operation S3, it is also possible to provide communication services differing with contract plans to even the legitimate mobile station 10 of the mobile network 30 in order to restrict uses other than contracted uses.

### 1.3) Effects

As described above, according to the exemplary embodiment of the present invention, it is determined based on the mobile station contract information of the mobile station 10 whether or not to permit the mobile station 10 to connect to the other mobile network 40 via the mobile station 20. Thus, it is possible to prevent malicious uses of a system in which access to another network is possible via anther mobile station.

Moreover, communication services provided when access is made to another network via another mobile station are differentiated between legitimate users and other users, whereby it is possible to foster legitimate uses of networks. Further, even when authorized access is made to another network via another mobile station, different communication services are provided based on the contents of the mobile station contract information such as a contract plan, whereby it is also possible to promote the provision of desired services.

### 2. Device Configuration

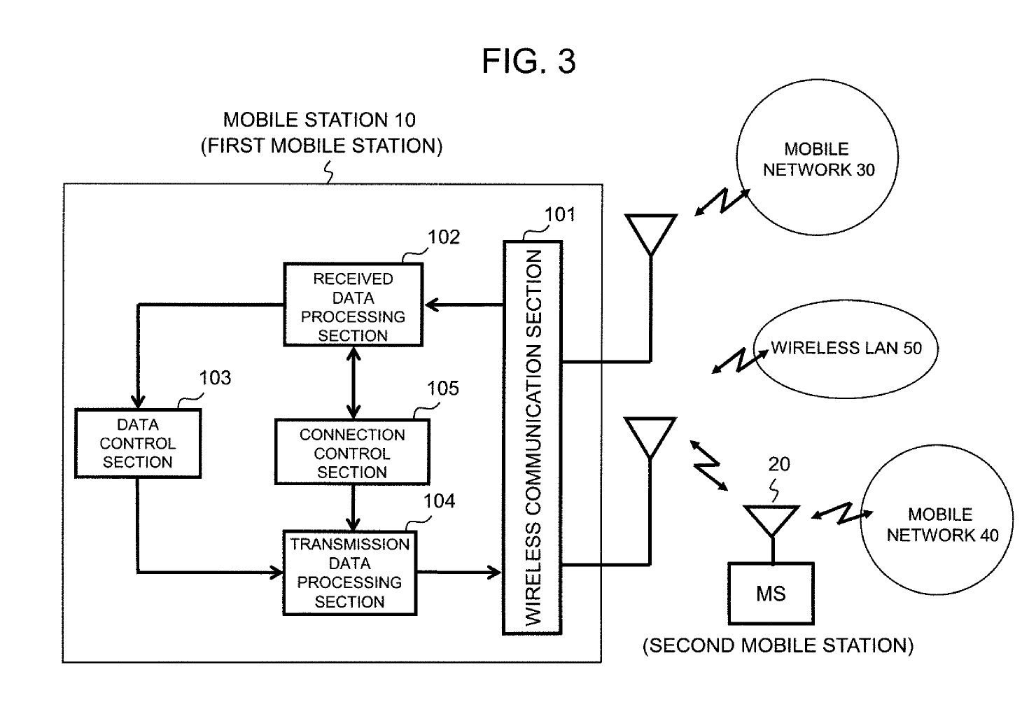

Hereinafter, the schematic configurations of the above-described mobile stations 10 and 20 and the upper-level network device 70 will be described with reference to FIGS. 3 to 5.

### 2.1) Mobile Station 10 (First Mobile Station)

Referring to FIG. 3, the mobile station 10 is a multi-mode terminal such as a smartphone supporting a plurality of radio access schemes. A wireless communication section 101 of the mobile station 10 wirelessly connects to a base station BS in the mobile network 30 by using a predetermined radio access scheme (e.g., UTRAN (UMTS Terrestrial Radio Access Network), E-UTRAN (Evolved UTRAN), GERAN (GSM EDGE Radio Access Network), WiMAX (Worldwide Interoperability for Microwave Access), or the like), and thus can communicate with an end node via the mobile network 30. Moreover, it can also communicate with an end node via the wireless LAN 50 by using a wireless LAN scheme. Further, the wireless communication section 101 wirelessly connects to the mobile station 20 by using a radio access scheme for Wireless LAN, Wireless PAN, or the like as described above, and thus can communicate with an end node via the mobile station 20 and the mobile network 40.

The mobile station 10 further includes a received data processing section 102, a data control section 103, a transmission data processing section 104, and a connection control section 105. The received data processing section 102 and the transmission data processing section 104 process data received from and to be transmitted to the mobile network 30, the wireless LAN 50, or the mobile station 20 in accordance with control by the connection control section 105, while the data control section 103 performs control and the like over the transmission data processing section 104 in accordance with received data.

The connection control section 105 can control the transmission data processing section 104, for example, so as to read mobile station contract information or terminal information stored in a memory (not shown) and send it. Note that the mobile station contract information or its related information may be downloaded by requesting it from the upper-level network as necessary. Moreover, it is also possible that the connection control section 105 controls the transmission data processing section 104 so as to send a request for connection to a network to the mobile station 20 depending on the link quality in the mobile network 30 and the wireless LAN 50, and stores a result of network connection permission/non-permission determination received from the mobile station 20.

Moreover, it is also possible that the connection control section 105 reads (or downloads from a network) the mobile station contract information, determines, before sending a connection request, whether or not its own station is permitted to connect to a network, and if a connection is permitted, controls the transmission data processing section 104 so as to send a connection request to the mobile station 20, which will be described later.

### 2.2) Mobile Station 20 (Second Mobile Station)

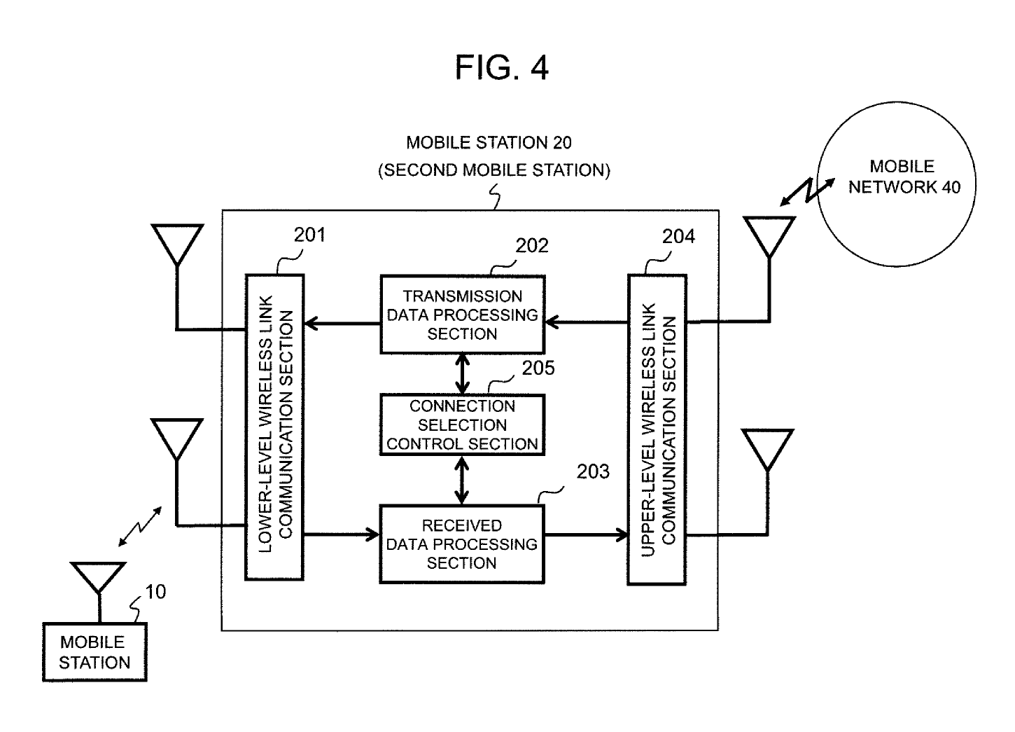

Referring to FIG. 4, the mobile station 20 is, for example, a smartphone having tethering function or a mobile router such as a WiFi router as described already, and performs control for transferring data transmitted and received between the mobile station 10 and the mobile network 40. A lower-level wireless link communication section 201 wirelessly connects to the mobile station 10 by using a radio access scheme for Wireless LAN, Wireless PAN, or the like as described above, transmits transmission data from a transmission data processing section 202 to the mobile station 10, and also outputs data received from the mobile station 10 to a received data processing section 203. An upper-level wireless link communication section 204 wirelessly connects to a base station in the mobile network 40 by using the above-described same radio access scheme that is used for the mobile station 10 or a different radio access scheme, and thus can communicate with the mobile network 40.

A connection selection control section 205 determines whether or not to permit a connection in response to a connection request from the mobile station 10, based on mobile station contract information received from the mobile station 10 or the upper-level network, and further can send a result of the determination to the mobile station 10. Alternatively, when connection permission/non-permission determination is performed at the upper-level network, it is also possible that the connection selection control section 205 transfers the mobile station contract information to the upper-level network via the mobile network 40, and upon receiving a result of the connection permission/non-permission determination, the connection selection control section 205 transfers it to the mobile station 10. Further, it is also possible that the connection selection control section 205 keeps the mobile station contract information and terminal information (MAC address and the like) of the mobile station 10 and uses them for filtering data to be transmitted and received.

### 2.3) Upper-Level Network Device 70 (Upper-Level Network)

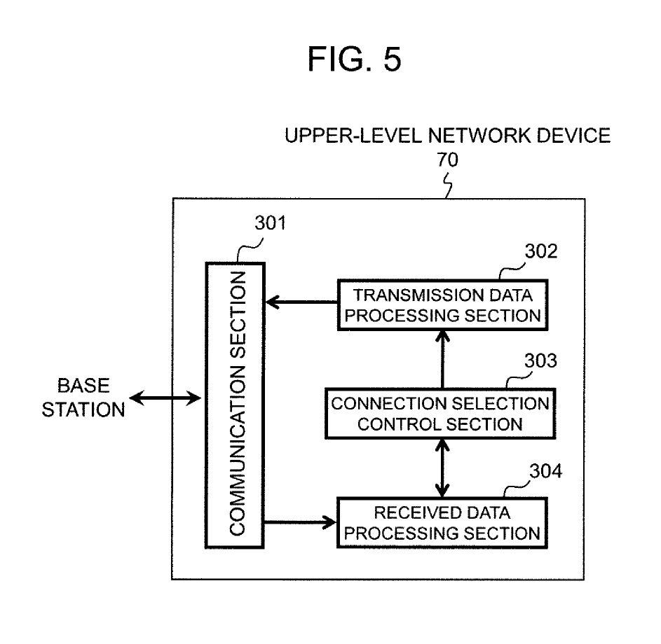

Referring to FIG. 5, the upper-level network device 70 includes a communication section 301 for communicating with base stations in the mobile network 40, a transmission data processing section 302, and a received data processing section 304. Further, when it is determined whether or not to permit a user to connect to a network, a connection selection control section 303 can determine, based on mobile station contract information received from a lower-level network, whether or not to permit a connection of the relevant mobile station 10, and return a result thereof. Note that the upper-level network device 70 is an HSS (Home Subscriber Server), an upper-level server capable of obtaining mobile station contract information from a HSS, or the like.

Hereinafter, a detailed description will be given of a network connection control method for a communication system to which the above-described exemplary embodiment of the present invention is applied, with reference to drawings.

### 3. First Example

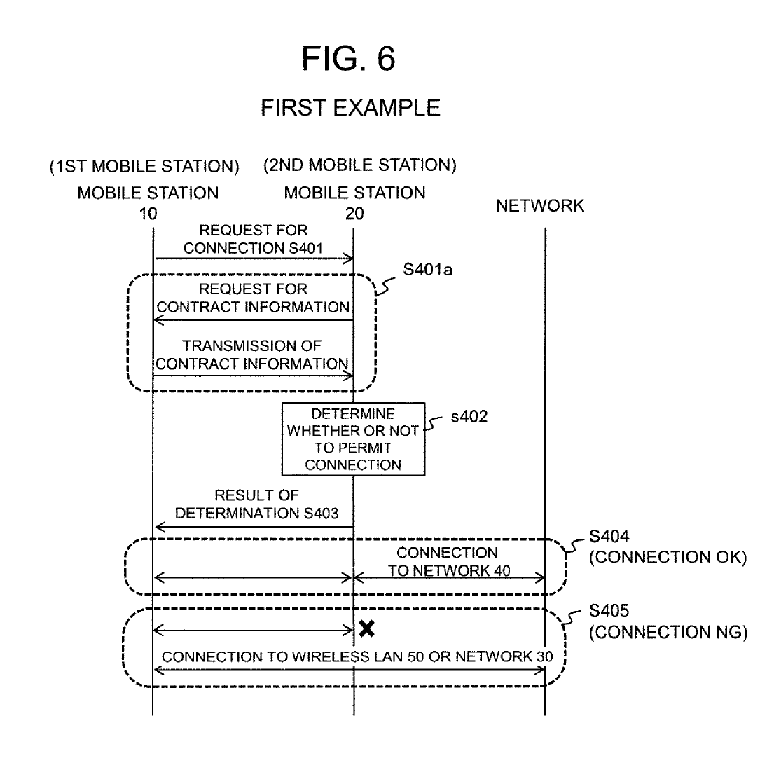

According to a first example of the present invention, the mobile station 20, which can access the mobile network 40, determines whether or not a predetermined condition is satisfied, in response to a connection request from the mobile station 10. Hereinafter, system operations according to the first example and specific examples of the mobile stations 10 and 20 will be described with reference to FIGS. 6 to 10.

### 3.1) System Operations

Referring to FIG. 6, it is assumed that the mobile station 10 makes a request to the mobile station 20 for a connection (Operation S401). At this time, the mobile station 10 may notify mobile station contract information (SIM information, contract plan information, and the like as described above) along with the connection request. Alternatively, it is also possible that the mobile station 20 having received the connection request makes a request to the mobile station 10 for contract information, and the mobile station 10, in response to that, sends the mobile station contract information of its own station to the mobile station 20 (Operation S401a).

The mobile station 20 having received the connection request and the mobile station contract information from the mobile station 10 determines whether or not to permit a connection based on the mobile station contract information as described with FIG. 2 (Operation S402), and sends a result of that determination to the mobile station 10 (Operation S403). When access of the mobile station 10 to the mobile network 40 is permitted (Connection OK), data from the mobile station 10 is transferred to the mobile network 40, while data destined to the mobile station 10 from the mobile network 40 is transferred to the mobile station 10 (Operation S404). At that time, the identification of data is performed based on the MAC address of the mobile station 10. In the case where access to the mobile network 40 is not permitted (Connection NG), the mobile station 10, when having been notified of non-permission of a connection, switches links to connect to the wireless LAN 50 or the mobile network 30, and thus can transmit and receive data (Operation S405).

In the above-described system sequence, the mobile stations 10 and 20 individually perform control, which will be described next.

### 3.2) Control Operations of Mobile Stations

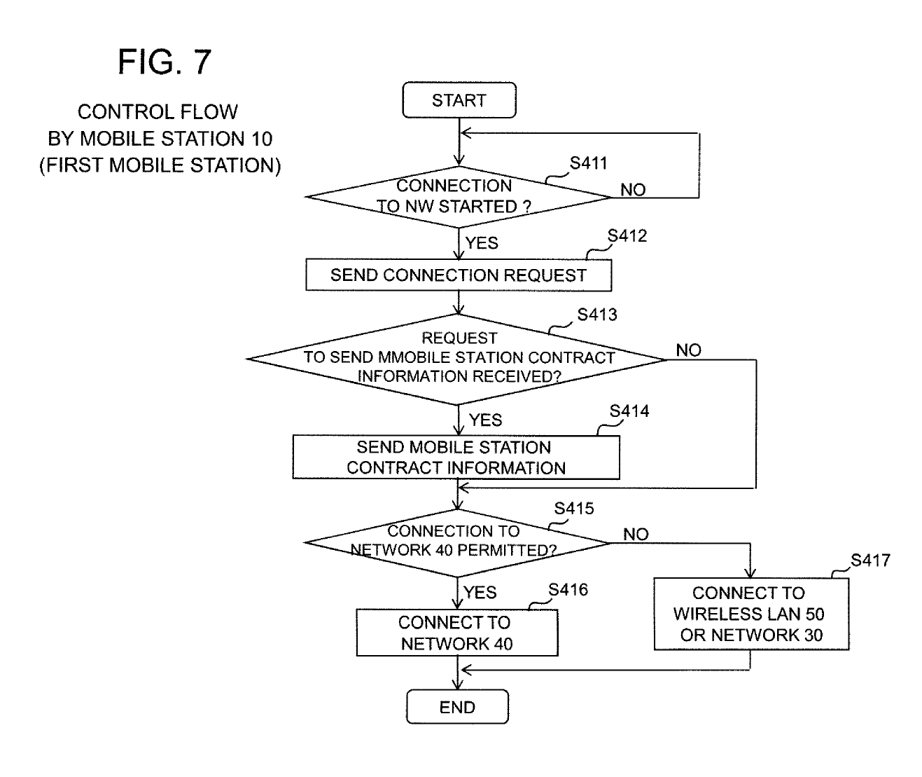

Referring to FIG. 7, when the mobile station 10 starts connecting to a network (Operation S411; YES), the connection control section 105 controls the transmission data processing section 104, so that a connection request is sent to the mobile station 20 through the wireless communication section 101 (Operation S412). Subsequently, if a request to send contract information is received from the mobile station 20 (Operation S413; YES), the data control section 103 reads mobile station contract information stored in the memory and sends the mobile station contract information to the mobile station 20 via the transmission data processing section 104 and the wireless communication section 101 (Operation S414). Operation S414 is not performed when a request to send contraction information is not received (Operation S413; NO). Subsequently, upon receiving from the mobile station 20 a result of connection permission/non-permission determination, in which a connection to the network is permitted (Operation S415; YES), the connection control section 105 connects to the mobile network 40 through a wireless connection between the wireless communication section 101 and the mobile station 20 (Operation S416). When a connection to the network is not permitted (Operation S415; NO), the connection control section 105 has the wireless communication section 101 connect to a base station in the wireless LAN 50 or the mobile network 30 (Operation S417). Note that if a result of the connection permission/non-permission determination from the mobile station 20 is limited permission such as low-speed communication, it is also possible for the connection control section 105 to connect to the mobile network 40 by the user's consent.

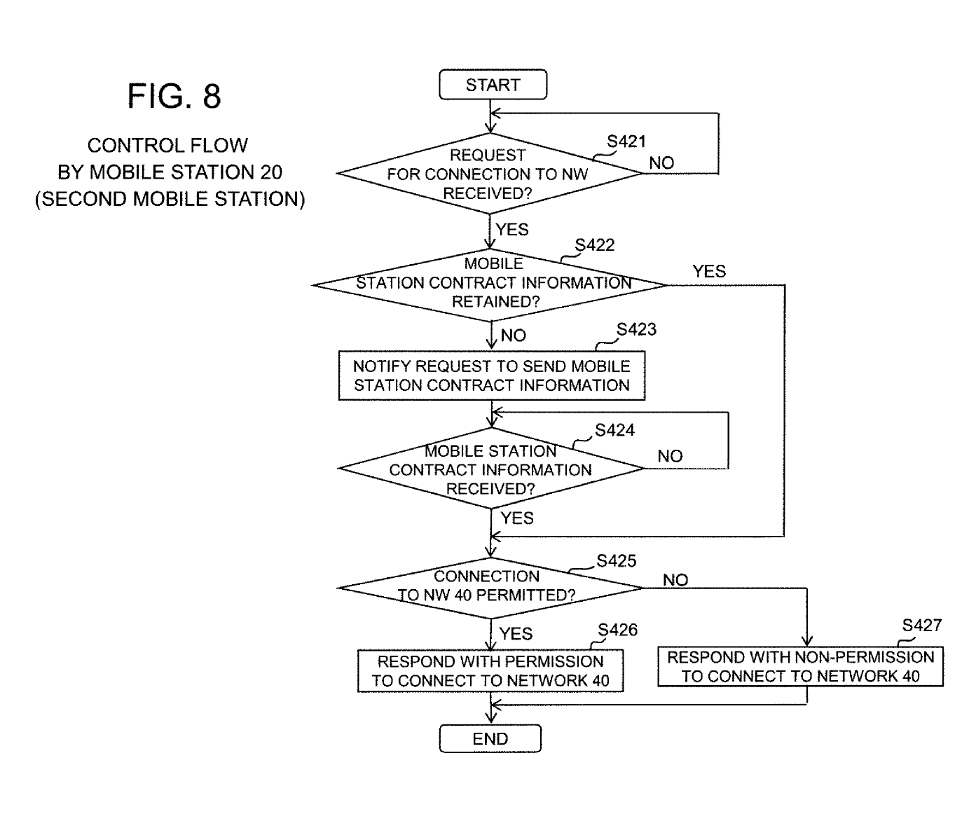

Referring to FIG. 8, when the mobile station 20 has received a connection request from the mobile station 10 (Operation S421; YES), the connection selection control section 205 determines whether or not mobile station contract information of this mobile station 10 is retained (Operation S422). If it is not retained (Operation S422; NO), a request to send contract information is sent to the mobile station 10 from the lower-level wireless link communication section 201 (Operation S423). When the mobile station contract information is received in response to this request to send contract information (Operation S424; YES), or when the mobile station contract information is already retained (Operation S422; YES), the connection selection control section 205 performs connection permission/non-permission determination based on the mobile station contract information as described with FIG. 2 (Operation S425). When permitting a connection to the mobile station 40 (Operation S425; YES), the connection selection control section 205 sends a network connection permission response as a result of the connection permission/non-permission determination to the mobile station 10 from the lower-level wireless link communication section 201 (Operation S426). When not permitting a connection to the mobile station 40 (Operation S425; NO), the connection selection control section 205 sends a network connection non-permission response as a result of the connection permission/non-permission determination to the mobile station 10 from the lower-level wireless link communication section 201 (Operation S427). Note that if a result of the connection permission/non-permission determination is limited permission such as low-speed communication, a response including a notification to that effect may be sent to the mobile station 10.

Note that the operation for notifying connection permission/non-permission in Operations S426 and S427 may also be performed by turning on/off the wireless LAN function of the mobile station 20. For example, if the connection control section 105 of the mobile station 10 is set to always prioritize a wireless LAN link, the mobile station 10 is allowed to connect to the mobile network 40 via the mobile station 20 by turning on the wireless LAN function of the mobile station 20 (Operation S426; Connection OK). The mobile station 10 can be made to automatically connect to the mobile network 30 by turning off the wireless LAN function of the mobile station 20 (Operation S427; Connection NG).

### 3.3) Examples of Configuration of Mobile Stations

The above-described respective control operations of the mobile stations 10 and 20 can also be implemented by executing programs on a processor (computer) installed on each mobile station. Hereinafter, an example of implementation by using software will be described briefly.

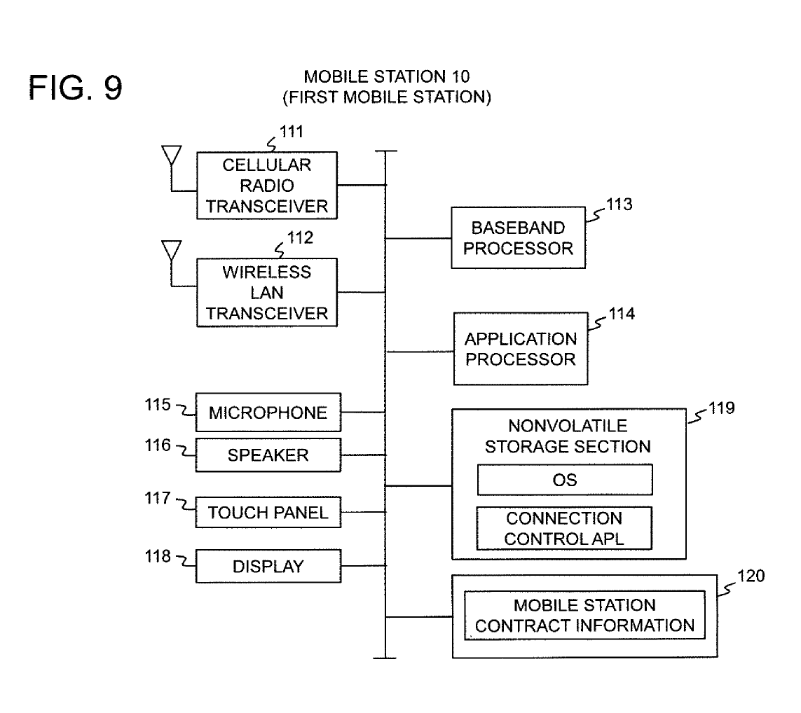

Referring to FIG. 9, the mobile station 10 includes, for the wireless communication section 101 in FIG. 3, a cellular radio transceiver 111, a wireless LAN transceiver 112, and a baseband processor 113. Moreover, as specific examples of input and output devices, a microphone 115, a speaker 116, a touch panel 117, and a display 118 are included. An application processor 114 implements various functions of the mobile station 10 by executing system software programs (OS (Operating System)) and programs of a link control application and various applications (e.g., web browser and mailer) read from a nonvolatile storage section 119.

The nonvolatile storage section 119 is, for example, a flash memory, a hard disk drive, or the like. The application processor 114 executes the link control application, whereby the above-described functions of the connection control section 105 are implemented. Moreover, the mobile station contract information is stored beforehand in the nonvolatile storage section 119 or another nonvolatile storage section 120 and sent to the mobile station 20 through the above-described link control process. Note that the connection control section 105 of the mobile station 10 may also be implemented by a semiconductor device including an ASIC or ASICs (Application Specific Integrated Circuit).

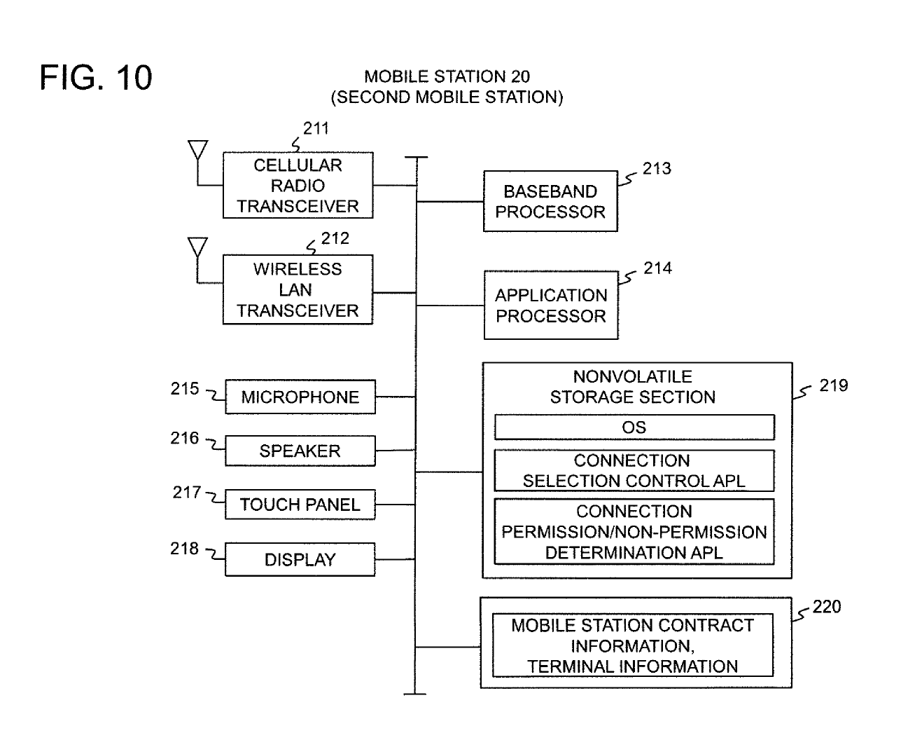

Referring to FIG. 10, the mobile station 20 includes, for the upper-level wireless link communication section 204 and the lower-level wireless link communication section 201 in FIG. 4, a cellular radio transceiver 211, a wireless LAN transceiver 212, and a baseband processor 213. Moreover, as specific examples of input and output devices, a microphone 215, a speaker 216, a touch panel 217, and a display 218 are included. An application processor 214 implements various functions, including the tethering function, of the mobile station 20 by executing system software programs (OS (Operating System)) and programs of a link selection control application, a connection permission/non-permission determination application, and various applications (e.g., web browser and mailer) read from a nonvolatile storage section 219.

The nonvolatile storage section 219 is, for example, a flash memory, a hard disk drive, or the like. The application processor 214 executes the connection selection control application and the connection permission/non-permission determination application, whereby the above-described functions of the connection selection control section 205 are implemented. Moreover, mobile station contract information and termination information received from the mobile station 10 are stored in the nonvolatile storage section 219 or another nonvolatile storage section 220 and used in the above-described link selection control process and connection permission/non-permission determination process. Note that the connection control section 205 of the mobile station 20 may also be implemented by a semiconductor device including an ASIC or ASICs (Application Specific Integrated Circuit).

The above-described various programs for the mobile stations 10 and 20 are stored by using various types of non-transitory computer readable media, and thus can be provided to the computers. The non-transitory computer readable media include various types of tangible storage media. Examples of non-transitory computer readable media include magnetic storage media (e.g., flexible disk, magnetic tape, and hard disk drive), magneto-optical storage media (e.g., magneto-optical disk), CD-ROM (Read Only Memory), CD-R, CD-R/W, and semiconductor memories (e.g., mask ROM, PROM (Programmable ROM), EPROM (Erasable PROM), flash ROM, and RAN (Random Access Memory)). Moreover, the programs may also be provided to the computers by using various types of transitory computer readable media. Examples of transitory computer readable media include electric signals, optical signals, and electromagnetic waves. The transitory computer readable media can provide the programs to the computers through a wired communication line such as electric wire or optical fiber, or through a wireless communication link.

### 4. Second Example

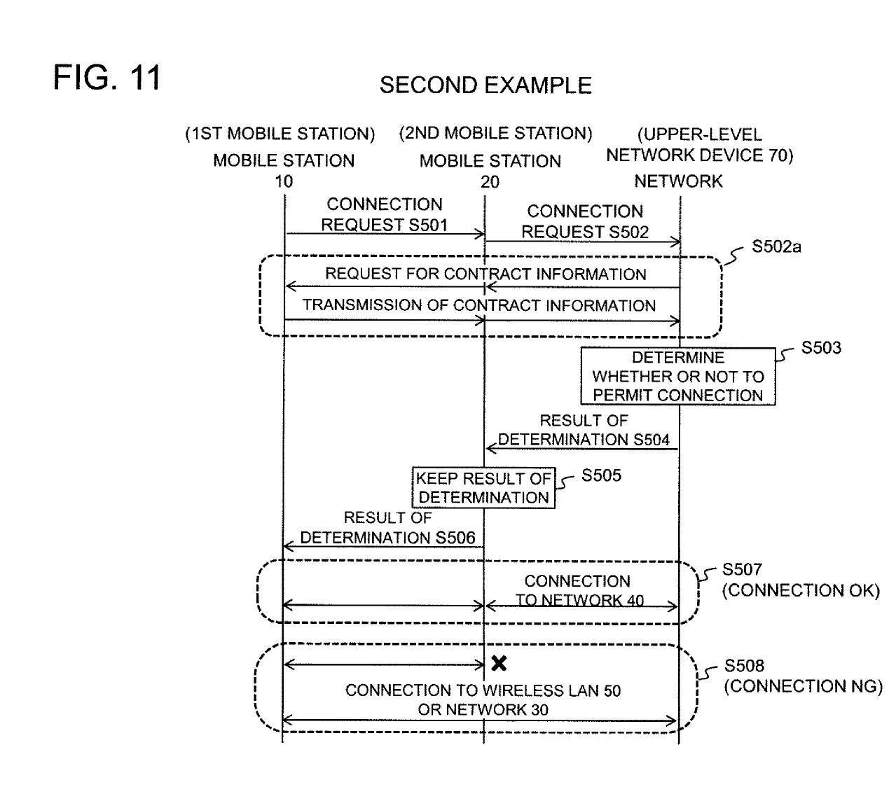

According to a second example of the present invention, the upper-level network device 70 determines whether or not an access condition is satisfied, in response to a connection request from the mobile station 10. Hereinafter, system operations and operations of the mobile station 20 and the high-order network device 70 according to the second example will be described with reference to FIGS. 11 to 13.

### 4.1) System Operations

Referring to FIG. 11, when receiving a connection request from the mobile station 10 (Operation S501), the connection selection control section 205 of the mobile station 20 transfers the connection request to the upper-level network device 70 via the mobile network 40 (Operation S502). In this event, if mobile station contract information (SIM information, contract plan information, and the like as described above) is also notified together from the mobile station 10, the mobile station 20 may also transfer it to the upper-level network device 70. Alternatively, it is also possible that the upper-level network device 70 having received the connection request makes a request to the mobile station 10 for contract information and, in response to that, the mobile station 10 sends the mobile station contract information (Operation S502a).

The upper-level network device 70, when having received the connection request and the mobile station contract information from the mobile station 20, performs connection permission/non-permission determination based on the mobile station contract information as described with FIG. 2 (Operation S503) and sends a result of the determination to the mobile station 20 (Operation S504). The mobile station 20 keeps the received result of the determination and the relevant termination information (Operation S505) and transfers the result of the determination to the mobile station 10 (Operation S506).

When access of the mobile station 10 to the mobile network 40 is permitted (Connection OK), the mobile station 20 transfers data from the mobile station 10 to the mobile network 40 and transfers data destined to the mobile station 10 from the mobile network 40 to the mobile station 10 (Operation S507). At this time, the identification of data is performed based on the MAC address of the mobile station 10. When access to the mobile network 40 is not permitted (Connection NG), the mobile station 10 having been notified of non-permission of a connection switches links to connect to the wireless LAN 50 or the mobile network 30 and thus can transmit and receive data (Operation S508).

In the above-described sequence, the mobile station 20 and the upper-level network device 70 perform control, which will be described next.

### 4.2) Control Operations

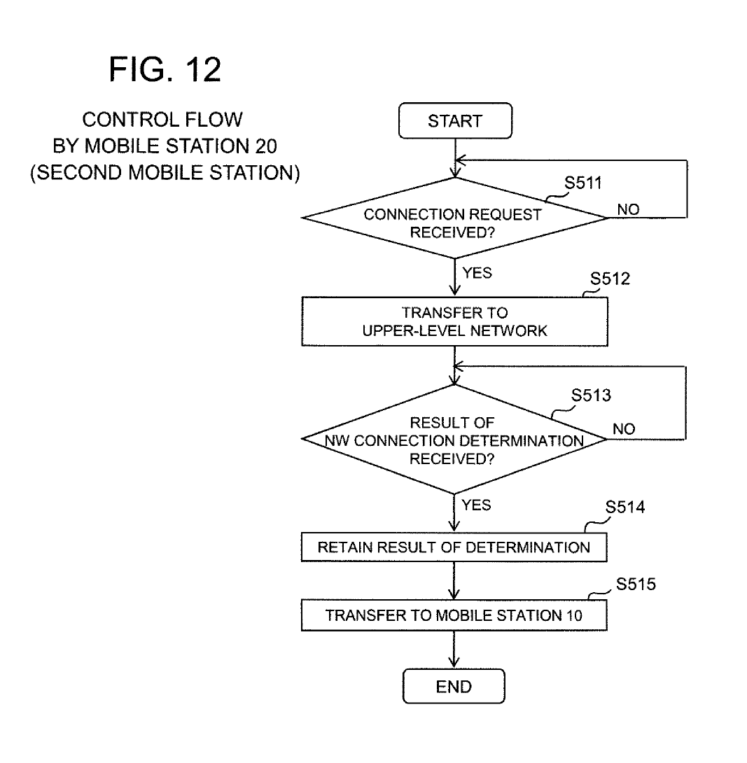

Referring to FIG. 12, when the mobile station 20 has received a connection request from the mobile station 10 (Operation S511; YES), the connection selection control section 205 transfers the connection request to the upper-level network (Operation S512) and waits for a result of connection determination from the upper-level network (Operation S513; NO). When receiving a result of connection determination from the upper-level network (Operation S513; YES), the connection selection control section 205 keeps this result of connection determination (Operation S514) and transfers it to the mobile station 10 (Operation 515).

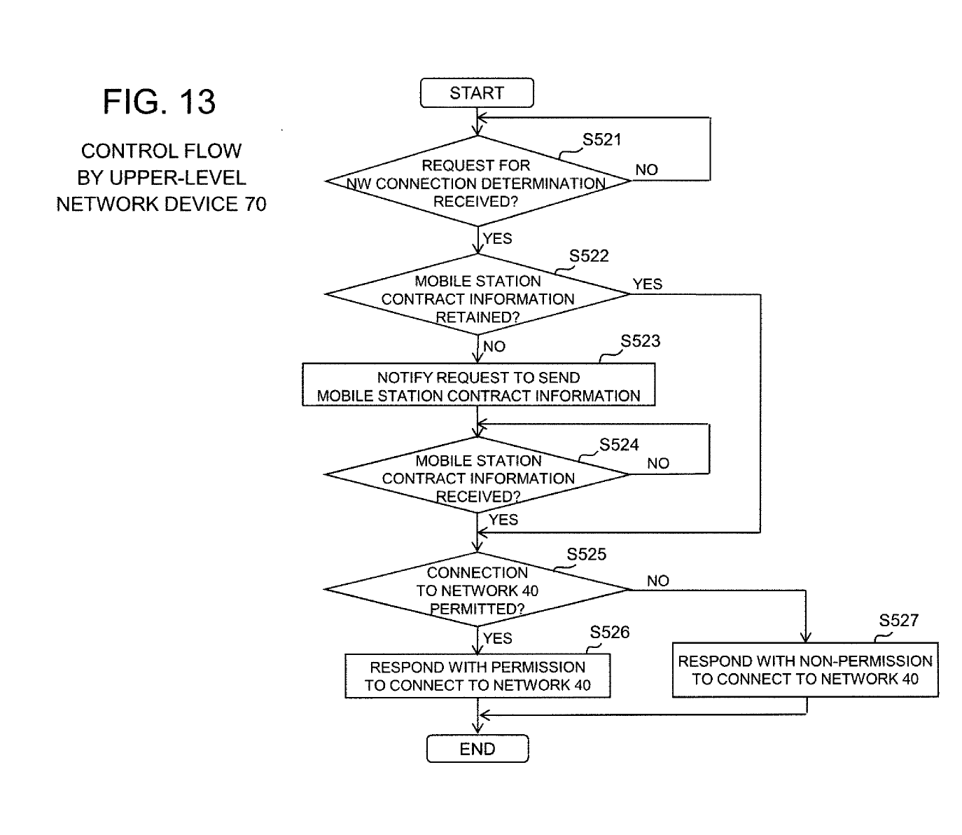

Referring to FIG. 13, when the upper-level network device 70 has received the connection request from the mobile station 20 (Operation S521; YES), the connection selection control section 303 determines whether or not the mobile station contract information of the mobile station 10 is retained (Operation S522) and, when it is not retained (Operation S522; NO), sends a request to send contract information to the mobile station 10 from the communication section 301 (Operation S523). When the mobile station contract information is received in response to this request to send contract information (Operation S524; YES), or when the mobile station contract information is already retained (Operation S522; YES), the connection selection control section 303 performs connection permission/non-permission determination based on the mobile station contract information as described with FIG. 2 (Operation S525). When permitting a connection to the mobile network 40 (Operation S525; YES), the connection selection control section 303 sends a network connection permission response as a result of the connection permission/non-permission determination to the mobile station 10 from the communication section 301 (Operation S526). When not permitting a connection to the mobile network 40 (Operation S525; NO), the connection selection control section 303 sends a network connection non-permission response as a result of the connection permission/non-permission determination to the mobile station 10 from the communication section 301 (Operation S527). Note that if a result of the connection permission/non-permission determination is limited permission such as low-speed communication, a response including a notification to that effect may be sent to the mobile station 10.

Note that the operation for notifying connection permission/non-permission in Operations S526 and S527 may also be performed by indicating to turn on/off the wireless LAN function of the mobile station 20. For example, if the connection control section 105 of the mobile station 10 is set to always prioritize a wireless LAN link, the mobile station 10 is allowed to connect to the mobile network 40 via the mobile station 20 by turning on the wireless LAN function of the mobile station 20 (Operation S526; Connection OK). The mobile station 10 can be made to automatically connect to the wireless LAN 50 or the mobile network 30 by turning off the wireless LAN function of the mobile station 20 (Operation S527; Connection NG).

As described above, according to the second example of the present invention, the upper-level network device 70 determines whether or not an access condition is satisfied in response to a connection request from the mobile station 10, whereby it becomes unnecessary to change the configurations and operations of the mobile stations 10 and 20.

### 5. Third Example

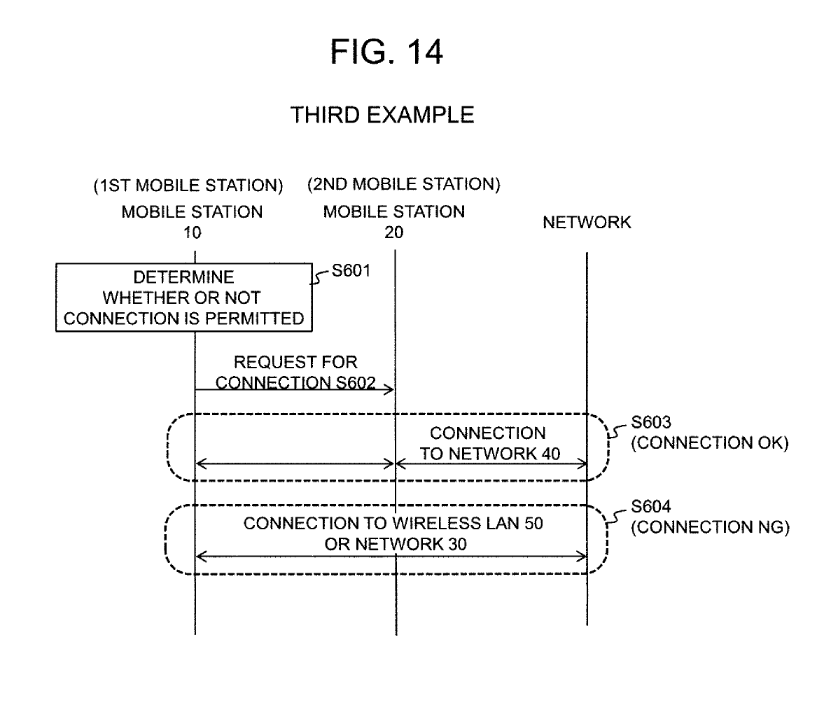

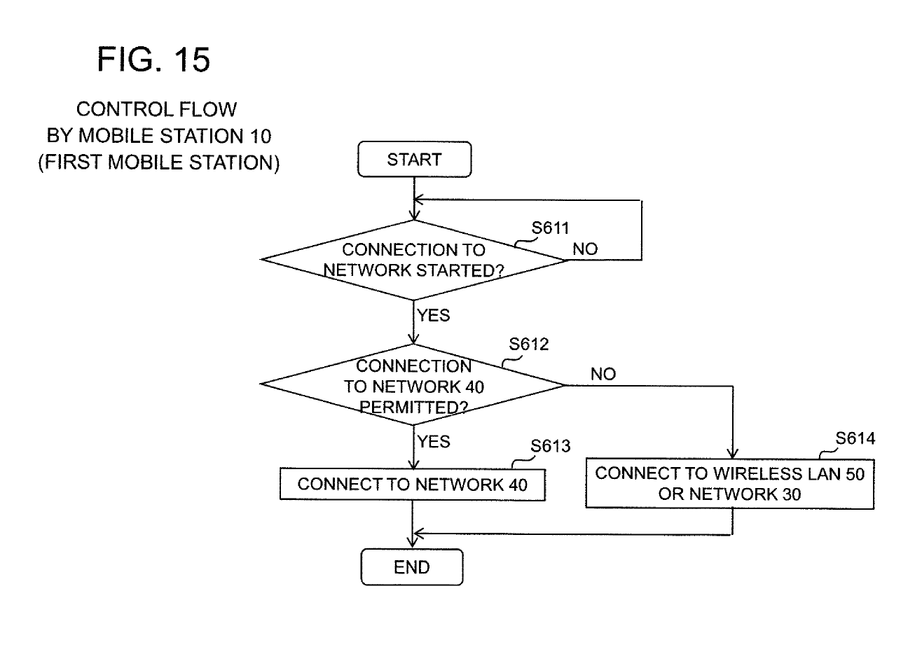

According to a third example of the present invention, the mobile station 10 determines whether or not a request from itself for a connection satisfies an access condition. Hereinafter, system operations and operations of the mobile station 10 according to the third example will be described with reference to FIGS. 14 and 15.

Referring to FIG. 14, when the mobile station 10 requests a connection to a network, the mobile station 10 performs connection permission/non-permission determination based on the mobile station contract information it retains, as described with FIG. 2 (Operation S601). When the connection request satisfies a condition for access to the mobile network 40, the mobile station 10 sends this connection request to the mobile station 20 (Operation S602). The mobile station 20, upon receiving the connection request, immediately establishes a connection to the mobile network 40 (Operation S603). When the connection request does not satisfy a condition for access to the mobile network 40, the connection control section 105 connects to the wireless LAN 50 or the mobile network 30 (Operation S604).

Referring to FIG. 15, when the mobile station 10 attempts to start connecting to a network (Operation S611), the connection control section 105 reads the retained mobile station contract information and performs connection permission/non-permission determination as described with FIG. 2 (Operation S612). When the connection request satisfies the condition for access to the mobile network 40 (Operation S612; YES), the connection control section 105 sends this connection request to the mobile station 20 and connects to the mobile network 40 (Operation S613). When the connection request does not satisfy the condition for access to the mobile network 40 (Operation S612; NO), the connection control section 105 connects to the wireless LAN 50 or the mobile network 30 (Operation S614).

As described above, according to the third example of the present invention, the mobile station 10, before sending a connection request to the mobile station 20, determines by itself whether or not a connection to the mobile network 40 is permitted. Since the connection request is sent only when a connection is permitted, traffic load can be reduced.

### 6. Fourth Example

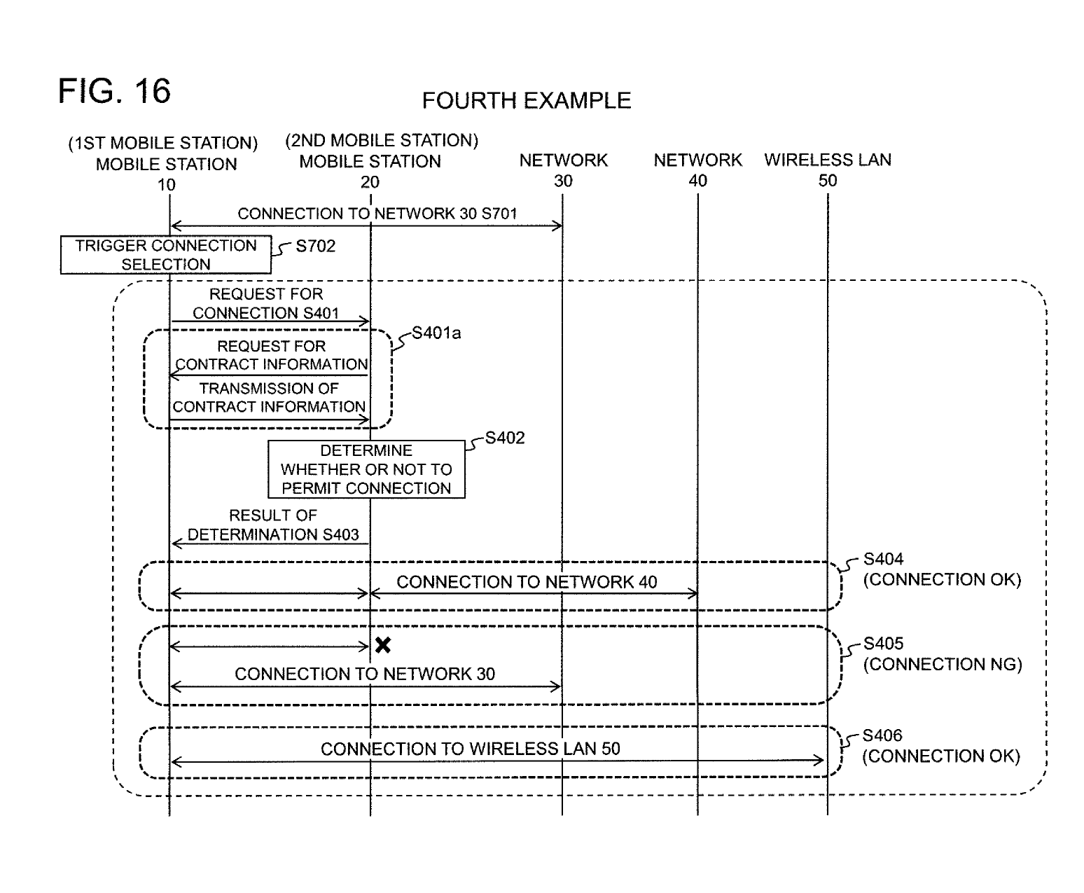

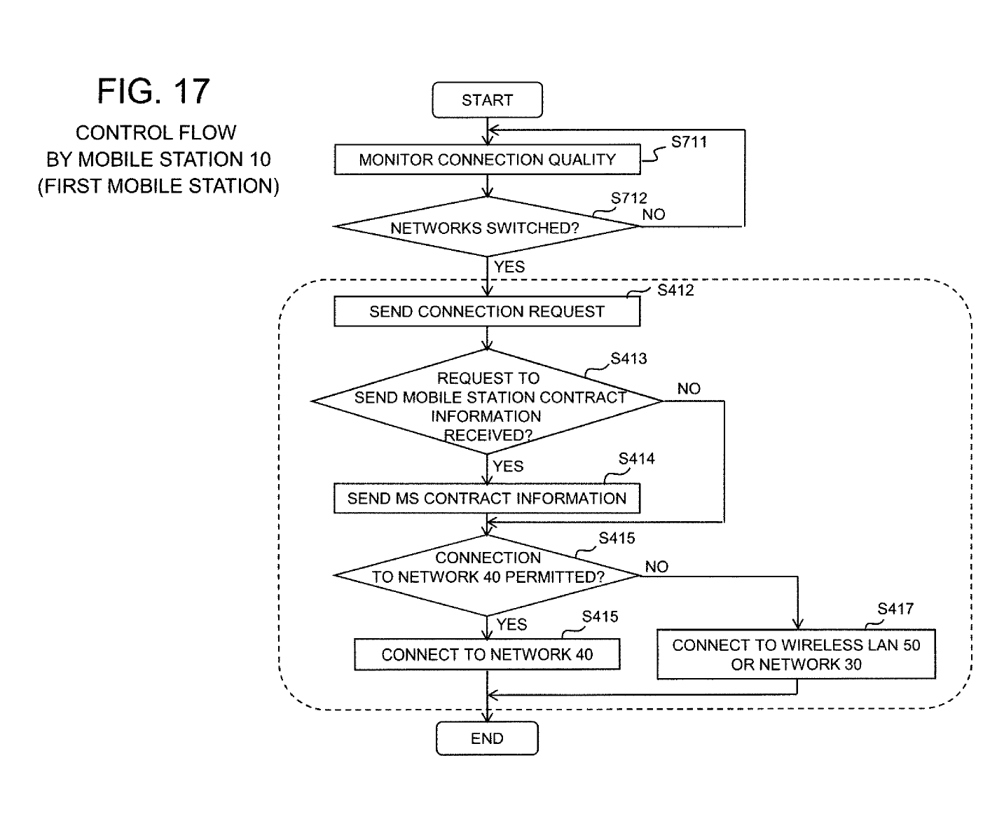

According to a fourth example of the present invention, when the mobile station 10 detects degradation in link quality when it is connected to the mobile network 30, the mobile station 10 can switch to a link on the mobile station 20 side or to the wireless LAN 50. The then connection permission/non-permission determination is performed by, for example, the mobile station 20 as in the above-described first example. Hereinafter, system operations and operations of the mobile station 10 according to the fourth example will be described with reference to FIGS. 16 and 17.

Referring to FIG. 16, it is assumed that the mobile station 10 is being connected to the mobile network 30 (Operation S701). At this time, when the mobile station 10 detects degradation in link quality, or a link disconnection, in the mobile network 30 (Operation S702), that triggers link selection, so that the mobile station 10 sends a connection request to the mobile station 20 if a link on the mobile network 40 side is better (Operation S401). Thereafter, Operations S401 to S403, with Operation S401a as an option, are performed as described in the first example shown in FIG. 6, and a connection to the mobile network 40 is allowed if Connection OK is determined (Operation S404). Note that when Connection NG is determined, a connection to the mobile network 30 is requested again (Operation S405). Moreover, if a connection to the wireless LAN 50 can be made, it is also possible that a connection to the wireless LAN 50 is made even if a connection to the network 40 is allowed (Operation S406).

Referring to FIG. 17, the connection control section 105 of the mobile station 10, when connected to the mobile network 30, monitors link quality on the mobile network 30 side and link quality on the mobile network 40 side (Operation S711) and, when the link quality degrades below a predetermined threshold, or a link disconnection occurs, on the mobile network 30 side, starts an operation for switching to a link on the mobile network 40 side (Operation S712; YES). Since a procedure for connecting to the mobile network 40 is the same as the flow shown in FIG. 7 (Operations S412 to S417), a description thereof, given the same reference signs, will be omitted.

As described above, according to the fourth example of the present invention, degradation in link quality or a link disconnection triggers the switching of links, whereby it is possible for the mobile station 10 to continue communication via a good-quality network, or to avoid a situation where a communication operation is interrupted for a long time.

### 7. Fifth Example

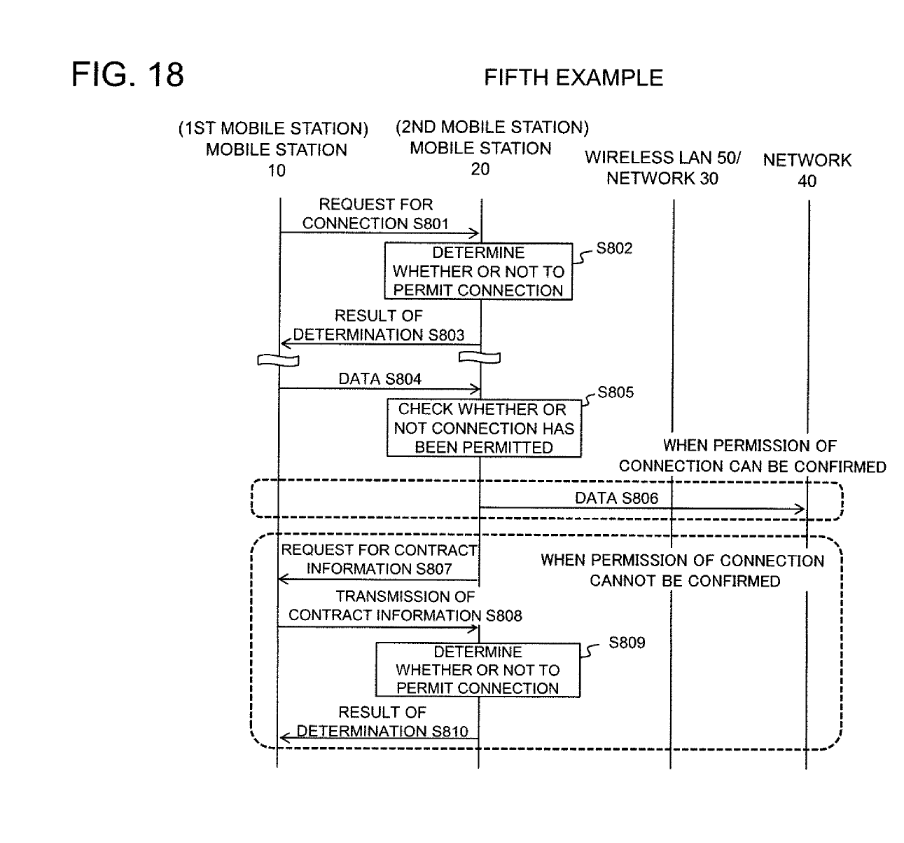

According to a fifth example of the present invention, once a connection to the mobile network 40 is permitted through connection permission/non-permission determination based on mobile station contract information as shown in FIG. 2, a connection to the network will be permitted without performing connection permission/non-permission determination again as long as the mobile station contract information is valid. Hereinafter, system operations and operations of the mobile stations 10 and 20 according to the fifth example will be described with reference to FIGS. 18 to 20, using a case as an example where the mobile station 20 determines whether or not to permit a connection as in the first example. Note that the same applies when the upper-level network device 70 determines whether or not to permit a connection as in the second example.

### 7.1) System Operations

Referring to FIG. 18, the mobile station 20 receives a connection request from the mobile station 10 (Operation S801), performs connection permission/non-permission determination based on mobile station contract information as described with FIG. 2 (Operation S802), and sends a result of that determination to the mobile station 10 (Operation S803). In the connection permission/non-permission determination, it is first determined whether or not the retained mobile station contract information is valid, and then it is determined based on the valid mobile station contract information whether or not to permit a connection. The validity of mobile station contract information can be set by using, for example, a limited lifetime.

When access of the mobile station 10 to the mobile network 40 is permitted (Connection OK), the mobile station 20 keeps the terminal information (MAC address or the like) of the mobile station 10 and, upon receiving data from the mobile station 10 (Operation S804), checks by using a source MAC address in the header of the data whether or not this terminal is the mobile station 10 whose connection has been permitted (Operation S805). When its connection has been permitted, the mobile station 20 transmits the data from this mobile station 10 to the mobile network 40 (Operation S806).

When the mobile station 20 is unable to confirm whether or not the connection has been permitted, the mobile station 20 requests contract information from the mobile station 10 (Operation S807). Upon receiving the mobile station contract information from the mobile station 10 in response thereto (Operation S808), the mobile station 20 performs connection permission/non-permission determination based on the mobile station contract information as described with FIG. 2 (Operation S809) and sends a result of that determination to the mobile station 10 (Operation S810). Thereafter, if Connection OK is determined, data from the mobile station 10 is transferred to the mobile network 40, while data destined to the mobile network 10 from the mobile network 40 is transferred to the mobile station 10. If Connection NG is determined, the mobile station 10 having been notified of non-permission of a connection switches links to connect to the wireless LAN 50 or the mobile network 30 and thus can transmit and receive data.

In the above-described sequence, the mobile stations 10 and 20 individually perform control, which will be described next.

### 7.2) Control Operations of Mobile Stations

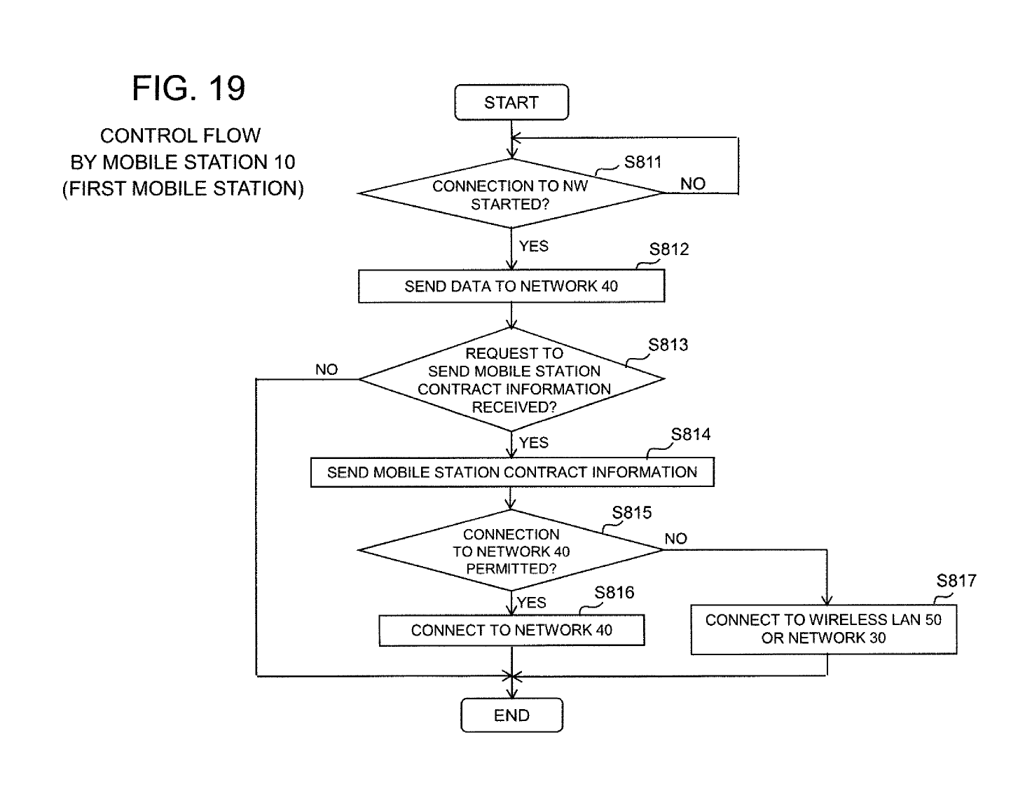

Referring to FIG. 19, when the mobile station 10 starts connecting to a network (Operation S811; YES), the connection control section 105 controls the transmission data processing section 104 to transmit data to the mobile station 20 from the wireless communication section 101 (Operation S812). Thereafter, if a request to send contract information is received from the mobile station 20 (Operation S813; YES), the connection control section 105 reads mobile station contract information stored in the memory and sends the mobile station contract information to the mobile station 20 via the transmission data processing section 104 and the wireless communication section 101 (Operation S814). If no request to send contract information is received (Operation S813; NO), it is determined that the connection has been permitted, and consequently the transmitted data is immediately transferred to the mobile network 40.

Subsequently, when a result of connection permission/non-permission determination is received from the mobile station 20 and indicates that a connection to the network is permitted (Operation S815; YES), the connection control section 105 connects to the mobile network 40 through a wireless connection between the wireless communication section 101 and the mobile station 20 (Operation S816). When a connection to the network is not permitted (Operation S815; NO), the connection control section 105 has the wireless communication section 101 connect to a base station in the wireless LAN 50 or the mobile network 30 (Operation S817). Note that if a result of connection permission/non-permission determination from the mobile station 20 is limited permission such as low-speed communication, it is also possible that the connection control section 105 connects to the mobile network 40 by the user's consent.

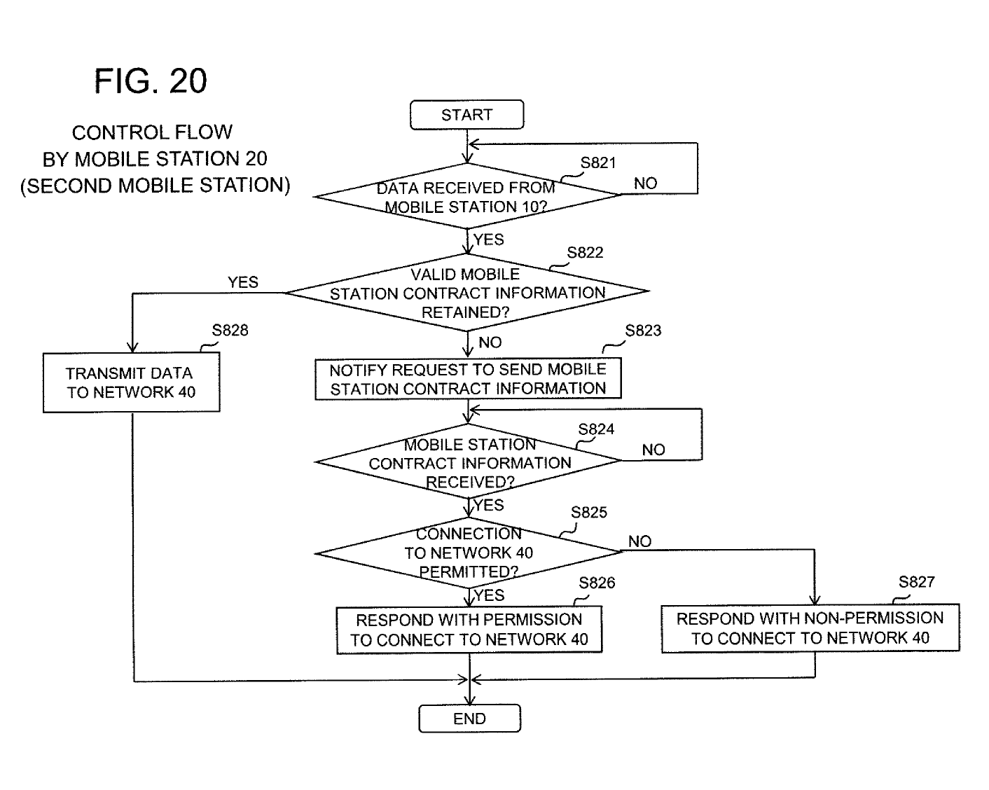

Referring to FIG. 20, when the mobile station 20 has received data from the mobile station 10 (Operation S821; YES), the connection selection control section 205 refers to the source's terminal information from the header of the data and determines whether or not the mobile station contract information of this terminal is retained with validity (Operation S822). If such mobile station contract information is not registered or if the mobile station contract information is not retained with validity (Operation S822; NO), a request to send contract information is sent to the mobile station 10 from the lower-level wireless link communication section 201 (Operation S823). When the mobile station contract information is received in response to this request to send contract information (Operation S824; YES), the connection selection control section 205 performs connection permission/non-permission determination based on the mobile station contract information as described with FIG. 2 (Operation S825). When permitting a connection to the mobile network 40 (Operation S825; YES), the connection selection control section 205 sends a network connection permission response as a result of the connection permission/non-permission determination to the mobile station 10 from the lower-level wireless link communication section 201 (Operation S826). When not permitting a connection to the mobile network 40 (Operation S825; NO), the connection selection control section 205 sends a network connection non-permission response as a result of the connection permission/non-permission determination to the mobile station 10 from the lower-level wireless link communication section 201 (Operation S827). Note that if a result of the connection permission/non-permission determination is limited permission such as low-speed communication, a response including a notification to that effect may be sent to the mobile station 10. When the mobile station contract information of the mobile station 10 is retained with validity (Operation S822; YES), the data from the mobile station 10 is immediately transmitted to the mobile network 40 (Operation S828).

Note that the operation for notifying connection permission/non-permission in Operations S826 and S827 may also be performed by turning on/off the wireless LAN function of the mobile station 20. For example, if the connection control section 105 of the mobile station 10 is set to always prioritize a wireless LAN link, the mobile station 10 is allowed to connect to the mobile network 40 via the mobile station 20 by turning on the wireless LAN function of the mobile station 20 (Operation S826; Connection OK). The mobile station 10 can be made to automatically connect to the wireless LAN 50 or the mobile network 30 by turning off the wireless LAN function of the mobile station 20 (Operation S827; Connection NG).

As described above, according to the fifth example of the present invention, once a connection to the mobile network 40 is permitted through connection permission/non-permission determination based on mobile station contract information as shown in FIG. 2, a connection to the network will be permitted without performing connection permission/non-permission determination again as long as the mobile station contract information is valid. Accordingly, it is possible to lighten load on the mobile station 20 and to reduce delays in connection.

### 8. Additional Statements

Part or all of the above-described exemplary embodiments also can be stated as in, but is not limited to, the following additional statements.

### (Additional Statement 1)

A communication system including a plurality of networks, comprising a first mobile station that can connect to a first network and a second mobile station that can connect to a second network, wherein the first mobile station has a function of connecting to the second network via the second mobile station, characterized in that

a connection of the first mobile station to the second network is controlled based on information concerning a contract for communication service uses in the first network (hereinafter, referred to as mobile station contract information).

### (Additional Statement 2)

The communication system according to additional statement 1, characterized in that when the mobile station contract information satisfies a predetermined access condition, the first mobile station is allowed to connect to the second network.

### (Additional Statement 3)

The communication system according to additional statement 2, characterized in that the predetermined access condition is information specifying a party to the contract and/or at least part of contents of the contract included in the mobile station contract information.

### (Additional Statement 4)

The communication system according to any one of additional statements 1 to 3, characterized in that the mobile station contract information is a telecommunication operator with which the first mobile station is under contract, a communication plan, and/or additional information to the mobile station contract information obtained from an upper-level network.

### (Additional Statement 5)

The communication system according to any one of additional statements 1 to 3, characterized in that the mobile station contract information is information preset between the first mobile station and the second network.

### (Additional Statement 6)

The communication system according to any one of additional statements 1 to 5, characterized in that the second mobile station determines whether or not to permit the connection of the first mobile station to the second network, based on the mobile station contract information.

### (Additional Statement 7)

The communication system according to any one of additional statements 1 to 5, characterized in that the second network determines whether or not to permit the connection of the first mobile station to the second network, based on the mobile station contract information.

### (Additional Statement 8)

The communication system according to additional statement 7, characterized in that the second mobile station obtains the mobile station contract information and sends it to the second network.

### (Additional Statement 9)

The communication system according to any one of additional statements 1 to 5, characterized in that the first mobile station determines whether or not the connection of its own station to the second network is permitted, based on the mobile station contract information.

### (Additional Statement 10)

The communication system according to any one of additional statements 1 to 5, characterized in that when a predetermined condition is satisfied, the first mobile station sends the mobile station contract information to the second mobile station.

### (Additional Statement 11)

The communication system according to additional statement 10, characterized in that the predetermined condition is when the first mobile station is connecting to a network.

### (Additional Statement 12)

The communication system according to additional statement 11, characterized in that the predetermined condition is when the first mobile station is started, or when connecting to a network is started, or when a network link connection is resumed.

### (Additional Statement 13)

The communication system according to additional statement 10, characterized in that the predetermined condition is when the mobile station contract information is requested to be sent.

### (Additional Statement 14)

The communication system according to additional statement 13, characterized in that the second mobile station notifies the first mobile station of a request to send the mobile station contract information.

### (Additional Statement 15)

The communication system according to any one of additional statements 1 to 5, characterized in that after the connection of the first mobile station to the second network is permitted based on the mobile station contract information, terminal information of the first mobile station is used, for a predetermined period of time, to determine whether or not to permit a connection to the second network.

### (Additional Statement 16)

A network connection control method in a communication system including a first mobile station that can connect to a first network and a second mobile station that can connect to a second network, wherein the method is for allowing the first mobile station to connect to the second network via the second mobile station, characterized by comprising:

controlling a connection of the first mobile station to the second network based on information concerning a contract for communication service uses in the first network (hereinafter, referred to as mobile station contract information).

### (Additional Statement 17)

The network connection control method according to additional statement 16, characterized in that when the mobile station contract information satisfies a predetermined access condition, the first mobile station is allowed to connect to the second network.

### (Additional Statement 18)

The network connection control method according to additional statement 17, characterized in that the predetermined access condition is a party to the contract and/or information specifying a party to the contract and/or at least part of contents of the contract included in the mobile station contract information.

### (Additional Statement 19)

The network connection control method according to any one of additional statements 16 to 18, characterized in that the mobile station contract information is a telecommunication operator with which the first mobile station is under contract, a communication plan, and/or additional information to the mobile station contract information obtained from a upper-level network.

### (Additional Statement 20)

The network connection control method according to any one of additional statements 16 to 18, characterized in that the mobile station contract information is information preset between the first mobile station and the second network.

### (Additional Statement 21)

The network connection control method according to any one of additional statements 16 to 20, characterized in that the second mobile station determines whether or not to permit the connection of the first mobile station to the second network, based on the mobile station contract information.

### (Additional Statement 22)

The network connection control method according to any one of additional statements 16 to 20, characterized in that the second network determines whether or not to permit the connection of the first mobile station to the second network, based on the mobile station contract information.

### (Additional Statement 23)

The network connection control method according to additional statement 22, characterized in that the second mobile station obtains the mobile station contract information and sends it to the second network.

### (Additional Statement 24)

The network connection control method according to any one of additional statements 16 to 20, characterized in that the first mobile station determines whether or not the connection of its own station to the second network is permitted, based on the mobile station contract information.

### (Additional Statement 25)

The network connection control method according to any one of additional statements 16 to 20, characterized in that when a predetermined condition is satisfied, the first mobile station sends the mobile station contract information to the second mobile station.

### (Additional Statement 26)

The network connection control method according to additional statement 25, characterized in that the predetermined condition is when the first mobile station is connecting to a network.

### (Additional Statement 27)

The network connection control method according to additional statement 26, characterized in that the predetermined condition is when the first mobile station is started, or when connecting to a network is started, or when a network link connection is resumed.

### (Additional Statement 28)

The network connection control method according to additional statement 25, characterized in that the predetermined condition is when the mobile station contract information is requested to be sent.

### (Additional Statement 29)

The network connection control method according to additional statement 28, characterized in that the second mobile station notifies the first mobile station of a request to send the mobile station contract information.

### (Additional Statement 30)

The network connection control method according to any one of additional statements 16 to 20, characterized in that after the connection of the first mobile station to the second network is permitted based on the mobile station contract information, terminal information of the first mobile station is used, for a predetermined period of time, to determine whether or not to permit a connection to the second network.

### (Additional Statement 31)

A communication device in a communication system including first and second networks and a mobile station that can connect to the first network, wherein the communication device can connect to the second network and has a function of allowing the mobile station to connect to the second network, characterized by comprising:

connection control means for controlling a connection of the mobile station to the second network, based on information concerning a contract for communication service uses in the first network (hereinafter, referred to as mobile station contract information).

### (Additional Statement 32)

The communication device according to additional statement 31, characterized in that when the mobile station contract information satisfies a predetermined access condition, the connection control means allows the mobile station to connect to the second network.

### (Additional Statement 33)

The communication device according to additional statement 32, characterized in that the predetermined access condition is information specifying a party to the contract and/or at least part of contents of the contract included in the mobile station contract information.

### (Additional Statement 34)

The communication device according to any one of additional statements 31 to 33, characterized in that the mobile station contract information is a telecommunication operator with which the mobile station is under contract, a communication plan, and/or additional information to the mobile station contract information obtained from an upper-level network.

### (Additional Statement 35)

The communication device according to any one of additional statements 31 to 33, characterized in that the mobile station contract information is information preset between the mobile station and the second network.

### (Additional Statement 36)

The communication device according to any one of additional statements 31 to 35, characterized in that when a predetermined condition is satisfied, the connection control means receives the mobile station contract information from the mobile station.

### (Additional Statement 37)

The communication device according to additional statement 36, characterized in that the predetermined condition is when the mobile station is connecting to a network.

### (Additional Statement 38)

The communication device according to additional statement 37, characterized in that the predetermined condition is when the first mobile station is started, or when connecting to a network is started, or when a network link connection is resumed.

### (Additional Statement 39)

The communication device according to additional statement 36, characterized in that the predetermined condition is when the mobile station contract information is requested to be sent.

### (Additional Statement 40)

The communication device according to additional statement 39, characterized in that the connection control means notifies the mobile station of a request to send the mobile station contract information.

### (Additional Statement 41)

The communication device according to any one of additional statements 31 to 35, characterized in that after the connection of the mobile station to the second network is permitted based on the mobile station contract information, the connection control means uses terminal information of the mobile station, for a predetermined period of time, to determine whether or not to permit a connection to the second network.

### (Additional Statement 42)

An upper-level network device in a communication system including a first mobile station that can connect to a first network and a second mobile station that can connect to a second network, wherein the first mobile station has a function of connecting to the second network via the second mobile station, the upper-level network device being provided in a upper-level network than a base station in the second network, characterized by comprising:

connection control means for controlling a connection of the first mobile station to the second network, based on information concerning a contract for communication service uses in the first network (hereinafter, referred to as mobile station contract information).

### (Additional Statement 43)

The upper-level network device according to additional statement 42, characterized in that when the mobile station contract information satisfies a predetermined access condition, the connection control means notifies the second mobile station of a result of determination to permit the connection of the first mobile station to the second network.

### (Additional Statement 44)

The upper-level network device according to additional statement 43, characterized in that the predetermined access condition is information specifying a party to the contract and/or at least part of contents of the contract included in the mobile station contract information.

### (Additional Statement 45)

The upper-level network device according to any one of additional statements 42 to 44, characterized in that the mobile station contract information is a telecommunication operator with which the first mobile station is under contract, a communication plan, and/or additional information to the mobile station contract information obtained from an upper-level network.

### (Additional Statement 46)

The upper-level network device according to any one of additional statements 42 to 44, characterized in that the mobile station contract information is information preset between the first mobile station and the second network.

### (Additional Statement 47)

The upper-level network device according to any one of additional statements 42 to 46, characterized in that the connection control means receives from the second mobile station the mobile station contract information obtained by the second mobile station.

### (Additional Statement 48)

The upper-level network device according to any one of additional statements 42 to 47, characterized in that the connection control means notifies the second mobile station of a result of determination to permit or not to permit the connection of the first mobile station to the second network, and the second mobile station keep that result of determination.

### (Additional Statement 49)

The communication device according to additional statement 48, characterized in that after the connection control means permits the connection of the first mobile station to the second network based on the mobile station contract information, the second mobile station uses terminal information of the first mobile station, for a predetermined period of time, to determine whether or not to permit a connection to the second network.

### (Additional Statement 50)

A communication device in a communication system including first and second networks and a mobile station that can connect to the second network, wherein the communication device can connect to the first network and is capable of wirelessly communicating with the mobile station, characterized by comprising:

storage means for storing information concerning a contract for communication service uses in the first network (hereinafter, referred to as mobile station contract information); and

connection control means for controlling a connection to the second network via the mobile station, based on the mobile station contract information.

### (Additional Statement 51)

The communication device according to additional statement 50, characterized in that when the mobile station contract information satisfies a predetermined access condition, the connection control means notifies the mobile station of a request for a connection to the second network.

### (Additional Statement 52)

The communication device according to additional statement 51, characterized in that the predetermined access condition is a party to the contract and/or information specifying a party to the contract and/or at least part of contents of the contract included in the mobile station contract information.

### (Additional Statement 53)

The communication device according to any one of additional statements 50 to 52, characterized in that the mobile station contract information is a telecommunication operator with which the communication device is under contract, a communication plan, and/or additional information to the mobile station contract information obtained from an upper-level network.

### (Additional Statement 54)

The communication device according to any one of additional statements 50 to 52, characterized in that the mobile station contract information is information preset with the second network.

### (Additional Statement 55)

The communication device according to any one of additional statements 50 to 54, characterized in that when a predetermined condition is satisfied, the connection control means sends the mobile station contract information to the mobile station.

### (Additional Statement 56)

The communication device according to additional statement 55, characterized in that the predetermined condition is when connecting to a network.

### (Additional Statement 57)

The communication device according to additional statement 56, characterized in that the predetermined condition is when the first mobile station is started, or when connecting to a network is started, or when a network link connection is resumed.

### (Additional Statement 58)

The communication device according to additional statement 55, characterized in that the predetermined condition is when the mobile station contract information is requested to be sent.

### (Additional Statement 59)

The communication device according to additional statement 58, characterized in that the connection control means receives from the mobile station a request to send the mobile station contract information.

### (Additional Statement 60)

A communication control method for a communication device in a communication system including first and second networks and a mobile station that can connect to the first network, wherein the communication device can connect to the second network and has a function of allowing the mobile station to connect to the second network, characterized by comprising:

controlling a connection of the mobile station to the second network, based on information concerning a contract for communication service uses in the first network (hereinafter, referred to as mobile station contract information).

### (Additional Statement 61)

A communication control method for an upper-level network device in a communication system including a first mobile station that can connect to a first network and a second mobile station that can connect to a second network, wherein the first mobile station has a function of connecting to the second network via the second mobile station, the upper-level network device being provided in a upper-level network than a base station in the second network, characterized by comprising:

controlling a connection of the first mobile station to the second network, based on information concerning a contract for communication service uses in the first network (hereinafter, referred to as mobile station contract information).

### (Additional Statement 62)

A communication control method for a communication device in a communication system including first and second networks and a mobile station that can connect to the second network, wherein the communication device can connect to the first network and is capable of wirelessly communicating with the mobile station, characterized by comprising:

storing information concerning a contract for communication service uses in the first network (hereinafter, referred to as mobile station contract information); and

controlling a connection to the second network via the mobile station, based on the mobile station contract information.

### INDUSTRIAL APPLICABILITY

The present invention is applicable to mobile communication systems using mobile routers, smartphones having tethering function, or the like.

### REFERENCE SIGNS LIST

10 Mobile station (first mobile station)
20 Mobile station (second mobile station)
30 Mobile network (first network)
40 Mobile network (second network)
50 Wireless LAN
60 External network
70 Upper-level network device

1. A communication system including a plurality of networks, comprising:
a first mobile station that is capable of connecting to a first network; and
a second mobile station that is capable of connecting to a second network,
wherein the first mobile station has a function of connecting to the second network via the second mobile station,
wherein a connection of the first mobile station to the second network is controlled based on information concerning a contract for communication service uses in the first network (hereinafter, referred to as mobile station contract information).

2. The communication system according to claim 1, wherein when the mobile station contract information satisfies a predetermined access condition, the first mobile station is allowed to connect to the second network.

3. The communication system according to claim 2, wherein the predetermined access condition is information specifying a party to the contract and/or at least part of contents of the contract included in the mobile station contract information.

4. The communication system according to claim 1, wherein the mobile station contract information is a telecommunication operator with which the first mobile station is under contract, a communication plan, and/or additional information to the mobile station contract information obtained from an upper-level network.

5. The communication system according to claim 1, wherein the mobile station contract information is information preset between the first mobile station and the second network.

6. The communication system according to claim 1, wherein the second mobile station determines whether or not to permit the connection of the first mobile station to the second network, based on the mobile station contract information.

7. The communication system according to claim 1, wherein the second network determines whether or not to permit the connection of the first mobile station to the second network, based on the mobile station contract information.

8. The communication system according to claim 7, wherein the second mobile station obtains the mobile station contract information and sends it to the second network.

9. The communication system according to claim 1, wherein the first mobile station determines whether or not the connection of its own station to the second network is permitted, based on the mobile station contract information.

10. The communication system according to claim 1, wherein when a predetermined condition is satisfied, the first mobile station sends the mobile station contract information to the second mobile station.

11. The communication system according to claim 10, wherein the predetermined condition is when the first mobile station is connecting to a network.

12. The communication system according to claim 11, wherein the predetermined condition is when the first mobile station is started, or when connecting to a network is started, or when a network link connection is resumed.

13. The communication system according to claim 10, wherein the predetermined condition is when the mobile station contract information is requested to be sent.

14. The communication system according to claim 13, wherein the second mobile station notifies the first mobile station of a request to send the mobile station contract information.

15. The communication system according to claim 1, wherein after the connection of the first mobile station to the second network is permitted based on the mobile station contract information, terminal information of the first mobile station is used, for a predetermined period of time, to determine whether or not to permit a connection to the second network.

16. A network connection control method in a communication system including a first mobile station that can connect to a first network and a second mobile station that can connect to a second network, wherein the method is for connecting the first mobile station to the second network via the second mobile station, comprising:
controlling a connection of the first mobile station to the second network based on information concerning a contract for communication service uses in the first network (hereinafter, referred to as mobile station contract information).

17. The network connection control method according to claim 16, wherein when the mobile station contract information satisfies a predetermined access condition, the first mobile station is allowed to connect to the second network.

18. The network connection control method according to claim 17, wherein the predetermined access condition is information specifying a party to the contract and/or at least part of contents of the contract included in the mobile station contract information.

19. The network connection control method according to claim 16, wherein the mobile station contract information is a telecommunication operator with which the first mobile station is under contract, a communication plan, and/or additional information to the mobile station contract information obtained from a upper-level network.

20. The network connection control method according to claim 16, wherein the mobile station contract information is information preset between the first mobile station and the second network.

21. The network connection control method according to claim 16, wherein the second mobile station determines whether or not to permit the connection of the first mobile station to the second network, based on the mobile station contract information.

22. The network connection control method according to claim 16, wherein the second network determines whether or not to permit the connection of the first mobile station to the second network, based on the mobile station contract information.

23. The network connection control method according to claim 22, wherein the second mobile station obtains the mobile station contract information and sends it to the second network.

24. The network connection control method according to claim 16, wherein the first mobile station determines whether or not the connection of its own station to the second network is permitted, based on the mobile station contract information.

25. The network connection control method according to claim 16, wherein when a predetermined condition is satisfied, the first mobile station sends the mobile station contract information to the second mobile station.

26. The network connection control method according to claim 25, wherein the predetermined condition is when the first mobile station is connecting to a network.

27. The network connection control method according to claim 26, wherein the predetermined condition is when the first mobile station is started, when its connecting to a network is started, or when a network link connection is resumed.

28. The network connection control method according to claim 25, wherein the predetermined condition is when the mobile station contract information is requested to be sent.

29. The network connection control method according to claim 28, wherein the second mobile station notifies the first mobile station of a request to send the mobile station contract information.

30. The network connection control method according to claim 16, wherein for a predetermined period of time after the connection of the first mobile station to the second network is permitted based on the mobile station contract information, terminal information of the first mobile station is used to determine whether or not to permit a connection to the second network.

31. A communication device in a communication system including first and second networks and a mobile station that can connect to the first network, wherein the communication device can connect to the second network and has a function of allowing the mobile station to connect to the second network, comprising:
a connection controller for controlling a connection of the mobile station to the second network, based on information concerning a contract for communication service uses in the first network (hereinafter, referred to as mobile station contract information).

32. The communication device according to claim 31, wherein when the mobile station contract information satisfies a predetermined access condition, the connection controller allows the mobile station to connect to the second network.

33. The communication device according to claim 32, wherein the predetermined access condition is information specifying a party to the contract and/or at least part of contents of the contract included in the mobile station contract information.

34. An upper-level network device in a communication system including a first mobile station that can connect to a first network and a second mobile station that can connect to a second network, wherein the first mobile station has a function of connecting to the second network via the second mobile station, the upper-level network device being provided in a upper-level network than a base station in the second network, comprising:
a connection controller for controlling a connection of the first mobile station to the second network, based on information concerning a contract for communication service uses in the first network (hereinafter, referred to as mobile station contract information).

35. The upper-level network device according to claim 34, wherein when the mobile station contract information satisfies a predetermined access condition, the connection controller notifies the second mobile station of a result of determination to permit the connection of the first mobile station to the second network.

36. The upper-level network device according to claim 35, wherein the predetermined access condition is information specifying a party to the contract and/or at least part of contents of the contract included in the mobile station contract information.

37. A communication device in a communication system including first and second networks and a mobile station that can connect to the second network, wherein the communication device can connect to the first network and is capable of wirelessly communicating with the mobile station, comprising:
a storage for storing information concerning a contract for communication service uses in the first network (hereinafter, referred to as mobile station contract information); and
a connection controller for controlling a connection to the second network via the mobile station, based on the mobile station contract information.

38. The communication device according to claim 37, wherein when the mobile station contract information satisfies a predetermined access condition, the connection controller notifies the mobile station of a request for a connection to the second network.

39. The communication device according to claim 38, wherein the predetermined access condition is information specifying a party to the contract and/or at least part of contents of the contract included in the mobile station contract information.

40. A communication control method for a communication device in a communication system including first and second networks and a mobile station that can connect to the first network, wherein the communication device can connect to the second network and has a function of allowing the mobile station to connect to the second network, comprising:
controlling a connection of the mobile station to the second network, based on information concerning a contract for communication service uses in the first network (hereinafter, referred to as mobile station contract information).

41. A communication control method for an upper-level network device in a communication system including a first mobile station that can connect to a first network and a second mobile station that can connect to a second network, wherein the first mobile station has a function of connecting to the second network via the second mobile station, the upper-level network device being provided in a upper-level network than a base station in the second network, comprising:
controlling a connection of the first mobile station to the second network, based on information concerning a contract for communication service uses in the first network (hereinafter, referred to as mobile station contract information).

42. A communication control method for a communication device in a communication system including first and second networks and a mobile station that can connect to the second network, wherein the communication device can connect to the first network and is capable of wirelessly communicating with the mobile station, comprising:
storing information concerning a contract for communication service uses in the first network (hereinafter, referred to as mobile station contract information); and
controlling a connection to the second network via the mobile station, based on the mobile station contract information.
